(19) United States
(12) Patent Application Publication
(10) Pub. No.: US 2022/0122173 A1
(43) Pub. Date: Apr. 21, 2022

(54) HIGH EFFICIENCY INTER-PORTFOLIO OPTIMIZER

(71) Applicant: Chicago Mercantile Exchange Inc., Chicago, IL (US)

(72) Inventors: Andrey Lopatin, Lisle, IL (US); Jingbin Yin, Naperville, IL (US); Jalpan Shah, Chicago, IL (US)

(73) Assignee: Chicago Mercantile Exchange Inc., Chicago, IL (US)

(21) Appl. No.: 17/076,154

(22) Filed: Oct. 21, 2020

(51) Int. Cl. G06Q 40/04; G06Q 10/04; G06Q 40/08; G06Q 10/10; G06Q 20/02; G06Q 40/00; G06N 7/00

(52) U.S. Cl. CPC G06Q 40/04; G06Q 10/04; G06Q 40/08; G06N 7/005; G06Q 20/023; G06Q 40/12; G06Q 10/10

(57) ABSTRACT

The disclosed embodiments relate to reducing, minimizing or otherwise optimizing margin requirements for a trader having both an interest rate (IR) futures and over-the-counter (OTC) interest rate swaps (IRS) accounts by efficiently allocating IR futures across both accounts.

### BACKGROUND

Recognizing the advantages to centralizing bilateral over the counter (“OTC”) and central counter party based trading, an electronic trading system may offer centralized clearing and risk mitigation of bilateral OTC transactions for bilateral OTC instruments using essentially the same clearing systems which are used for central counter party based transactions. This generally enables a particular electronic trading system, e.g. such as the electronic trading system operated by the Chicago Mercantile Exchange Inc., to offer a single system where trading entities may enter into and manage positions in both bilateral OTC instruments and listed instruments.

However, legal, business and/or regulatory requirements may require that positions, e.g., the data indicative thereof, entered by a trading entity into bilateral OTC instruments be maintained, at least upon entering those positions, separate, e.g., in a separate data structure or database, from positions in listed instruments entered into by that same trading entity.

Further, current margin systems are tailored to computing margin requirements for either listed or OTC instruments but not both combined, e.g., the models which are used to compute risk of loss for listed instruments may be tailored to the characteristics of listed instruments and therefore not suitable to compute risk of loss for OTC instruments necessitating a separate model tailored for OTC instruments.

Accordingly, computing a margin requirement for a trading entity holding positions in both OTC instruments and listed instruments requires summing the separately computed margin requirements of their positions in the OTC instruments and in the listed instruments.

However, it will be appreciated that a combination of one or more positions held in an OTC instrument, such as an Interest Rate Swap (“IRS”), with one or more positions held in listed instruments, such as an IR Futures contract, may present a lower risk of loss, which, if recognized, would reduce the overall margin requirement for the trading entity.

Margin (or risk of loss) for a portfolio of positions is generally computed by evaluating the positions in the portfolio alone and in combination under various hypothetical scenarios in order to derive an estimated risk of loss for the entire portfolio. While each position held in a portfolio may involve some risk of loss of itself, holding multiple positions may yield a combined risk of loss that is more or less than the sum of the risk of loss of each position individually. Where positions acquired by a trading entity in different trading systems must be kept separate, e.g., in separate portfolios, the process of evaluating the positions may be limited to evaluating each portfolio separately. In this situation, offsetting positions as between the two portfolios will not be recognized and, therefore, the minimal combined margin amount for the two portfolios will not be realized.

Some trading systems enable a trading entity to move at least some of their positions between these separate portfolios in order to minimize their combined margin requirement. By moving positions between portfolios, the overall margin requirement of each, due the presence or absence of offsetting positions, will change, e.g., one or both may go up and/or down by the same or different amounts, possibly resulting in a net change to the overall margin for the portfolio, either a net increase or net decrease.

However, determining which one or more listed positions to move in order to minimize an overall margin requirement is complex and it may not always be apparent, without a complete encyclopedic knowledge of the SPAN and HVAR models used to calculate margin requirements, which positions, e.g., in which instruments and how many, in which combinations will achieve the minimal margin requirement. In other words, the effect of transferring positions cannot be readily anticipated without actually testing the modified portfolios to calculate the margin values, and the minimal margin may not be readily determined without comparing those results with the results of other tests.

One way in which to determine which listed positions to transfer is via brute force-namely, by trying all possible combinations of transfers, computing the total margin, and selecting the lowest. However, the computational time associated with such a brute force method can be enormous for large portfolios and for precise calculations.

Additionally, there are negative consequences associated with misallocating listed positions across the two accounts. In fact, if done improperly, misallocating listed positions can result in higher margins than the base case (i.e., futures margined by themselves and swaps margined by themselves).

For example, current mechanisms will typically employ a business analyst for data aggregation, a quantitative analyst for computing optimized allocation of futures positions, and an operations analyst for inputting the resulting transfers into a graphical user interface (GUI). Due to the substantial overhead associated with current mechanisms such as this, an end user generally cannot optimize/rebalance a portfolio on a daily basis, thereby forgoing potential savings. In addition, the entry of transfers into the GUI by the operations analyst is susceptible to human user error (e.g., omission, mis-keys, etc.). Moreover, the operations analyst will typically have to enter both sides of any transfer trade (e.g., the buy transaction and the offsetting sell transaction) into the GUI for potentially dozens of contracts. Each side of the transaction can take approximately 30 seconds, which—from the point of view of trade processing alone—will correspond to about one minute per contract. Thus, without proper automation, only an extremely small subset of the universe of entities participating in these two markets would be able to realize initial margin capital efficiencies.

In particular, one may simply use the SPAN, e.g. PC SPAN, and HVAR models, to compute the margin requirements for each allocation scenario until the optimal scenario is determined. However, in addition to the potential large number of allocation scenarios that would need to be tested as described above, the SPAN and HVAR models are complex software programs designed to be executed infrequently, e.g. no more than once or twice per day, on any given portfolio of positions/products, e.g., they are designed to handle all possible position/product combinations available from the electronic trading system that a trading entity may hold. These programs evaluate any given portfolio against a complex and large set of pre-defined portfolio-generic rules and parameters determined at the time of execution, in a manner which is specifically configured and optimized for singular application to any given portfolio, i.e. to the actual allocations of the Listed positions.

As the amounts required by the Clearing House to be on account to cover a margin requirement may be significant and may reduce the amount of funds available to the account holder for other purposes, it is desirable to efficiently minimize the margin requirement when possible without otherwise expending unnecessary computational resources or compromising the adequacy of protection afforded to the Exchange.

### BRIEF DESCRIPTION OF THE DRAWINGS

FIG. 1 depicts a computer network system, according to some embodiments.

FIG. 2 depicts a general computer system, according to some embodiments.

FIG. 3 depicts a block diagram of an optimizer tool according to one embodiment.

FIGS. 4A-4P show example inputs and outputs of the system of FIGS. 3, 5 and 6 according to one embodiment.

FIG. 5 depicts a block diagram of a system for automatically enabling deferred physical delivery of a first quantity of an asset according to one embodiment.

FIG. 6 depicts a flow chart showing the operation of the system of FIG. 3 according to one embodiment.

### DETAILED DESCRIPTION

By way of general introduction, embodiments in accordance with the present teachings relate to a specific application of reducing, minimizing or otherwise optimizing margin requirements for a trading entity having a portfolio of positions in both listed instruments, such as an interest rate (IR) futures, and over-the-counter (OTC) instruments, such as interest rate swaps (IRS), held in separate accounts, by efficiently identifying an optimal allocation of the positions in IR futures across both accounts, as will be described, for the purpose of computing an overall margin requirement for the portfolio. In one embodiment, the optimal position allocation targets a reduction in the overall margin requirement. If such allocations cannot be found, e.g., the margin requirement is already zero or represents a margin credit, no transfers between the accounts will be suggested or performed and the margin requirements remain unchanged. In an alternatively embodiment, the optimal allocation will be one which minimizes margin collected or maximizes margin credit.

Financial instruments may be traded via different electronic trading systems. These systems may be characterized as either being bilateral or centrally cleared. In bilateral trading systems, often referred to as over the counter (OTC), trades are bilateral, e.g. negotiated directly between the parties, credit and risk of loss are handled by the parties, and OTC trades may involve standard or non-standard contract terms, depending upon the needs of the parties. It will be appreciated that once a bilateral trade is entered into, it may be submitted to a settlement system, such the Continuous Linked Settlement (CLS) system.

A forward contract, such as a currency forward contract, is an example of a contract which is traded via a bilateral trading system and calls for delivery of an asset at a later date for a price determined at the inception of the contract. For currencies, a currency forward contract is a bilateral contract for delivery, actual or cash settled depending on the contract terms, of an amount of a particular currency, e.g. Euros, at a future date at a price, delineated in a different currency, e.g. dollars, determined at the inception of the contract. Unlike a futures contract, discussed below, a forward contract is traded “over the counter,” bilateral, e.g. negotiated directly between the parties as discussed above, and may not be standardized as to its terms. Option contracts on a forward contract are also available offering the buyer thereof the right, but not the obligation, to sell or buy the underlying forward contract at a specified price on or before a certain expiration date. Forward contracts may be physically settled, e.g. via the delivery of the amount of the particular currency called for in the contract, or cash settled via delivery of the cash difference, denominated in currency of the contract price, between the contract price and the spot price of the currency to be delivered, which may be the differential in exchange rates between when the contract was entered into and the delivery date. Options contracts for the delivery of a specific currency may also be offered bilaterally and call for delivery of the requisite currency, as opposed to a forward contract therefore. Options contracts traded via a bilateral/OTC trading system may be referred to as OTC options or OTC options contracts.

An interest rate swap (“IRS”) is another example of a contract which is traded via a bilateral trading system. An IRS is a contractual agreement between two parties, i.e., the counterparties, also referred to as the payer and receiver, where one stream of future interest payments is exchanged for another, e.g., a stream of fixed interest rate payments in exchange for a stream of floating interest rate payments, based on a specified principal amount or an assumed notional amount. An IRS may be used to limit or manage exposure to fluctuations in interest rates. One common form of IRS exchanges a stream of floating interest rate payments on the basis of the 3-month London interbank offered rate (“LIBOR”) for a stream of fixed-rate payments on the basis of the swap's fixed interest rate. Another common form of IRS, known as an overnight index swap, exchanges, at its termination, a floating rate payment determined by daily compounding of a sequence of floating interest rates on the basis of an overnight interest rate reference (e.g., the US daily effective federal funds rate, or the European Overnight Index Average (EONIA)) over the life of the swap, for a fixed rate payment on the basis of daily compounding of the overnight index swap's fixed interest rate over the life of the swap.

The components of a typical IRS may be defined in a swap confirmation which is a document that is used to contractually outline the agreement between the two parties. The components defined in this agreement may include:
Notional—The fixed and floating coupons are paid out based on what is known as the notional principal or just notional. If one were hedging a loan with $1 million principal with a swap, then the swap would have a notional of $1 million as well. Generally the notional is never exchanged and is only used for calculating cash flow amounts;
Fixed Rate—This is the rate that will be used to calculate payments made by the fixed payer. This stream of payments is known as the fixed leg of the swap;
Coupon Frequency—This is how often coupons would be exchanged between the two parties, common frequencies are annual, semi-annual, quarterly and monthly though others are used such as based on future expiry dates or every 28 days. In a vanilla swap the floating and fixed coupons would have the same frequency but it is possible for the streams to have different frequencies;
Business Day Convention—This defines how coupon dates are adjusted for weekends and holidays. Typical conventions are Following Business Day and Modified Following;
Floating Index—This defines which index is used for setting the floating coupons. One common index is LIBOR. The term of the index will often match the frequency of the coupons. For example, 3 month LIBOR would be paid Quarterly while 6 month LIBOR would be paid Semi-Annually; Daycount conventions—These are used for calculating the portions of the year when calculating coupon amounts;
Effective Date—This is the start date of a swap and when interest will start accruing on the first coupon; and
Maturity Date—The date of the last coupon and when the obligations between the two parties end.

In contrast, central counter party-based trading utilizes an intermediary entity to separate the transacting parties such that they are prevented from transacting/negotiating directly with one another. For example, a central counterparty based electronic trading system, such as a futures exchange, such as the Chicago Mercantile Exchange Inc. (CME), provides a contract market where financial instruments, e.g., futures and options on futures, are traded using electronic systems. “Futures” is a term used to designate contracts for the purchase or sale of financial instruments or physical commodities for future delivery or cash settlement on a commodity futures exchange. A futures contract is a legally binding agreement to buy or sell a commodity at a specified price at a predetermined future time. An option contract is the right, but not the obligation, to sell or buy the underlying instrument (in this case, a futures contract) at a specified price, referred to as the strike price, on or before a certain expiration date. An option contract on a futures contract, e.g., having a futures contract as an underlier, offers an opportunity to take advantage of futures price moves without actually having a futures position and is considered “in the money” when the strike price is favorable to the market price of the underlier. The commodity to be delivered in fulfillment of the contract, or alternatively the commodity for which the cash market price shall determine the final settlement price of the futures contract, is known as the contract's underlying reference or “underlier.” The underlying or underlier for an options contract on a futures contract is the corresponding futures contract that is purchased or sold upon the exercise of the option. Options contracts traded via a central counterparty-based trading system may be referred to as Exchange Traded Derivative (ETD) options or ETD options contracts.

Typically, in contrast to a bilaterally traded contract, the terms and conditions of each futures contract are standardized as to the specification of the contract's underlying reference commodity, the composition of the commodity, quantity, delivery date, and means of contract settlement. Such standardization may improve the liquidity of these contracts, e.g. the ease with which such contracts may be bought or sold. In embodiments described herein, terms and conditions of each futures contract may be partially standardized as to the specification of the contract's underlying reference commodity and attributes thereof. Options on futures may be similarly standardized as to, for example, quantity, strike price and expiration/maturity. The underlying reference commodity may include a range of possible qualities, quantities, delivery dates, and other attributes. For a spot market transaction, the underlying quality and attributes may be set, while a futures contract may provide predetermined offsets to allow for possible settlement of a non-conforming delivery. Cash settlement is a method of settling a futures contract whereby the parties effect final settlement, when the contract expires, by paying/receiving the loss/gain related to the contract in cash, rather than by effecting physical sale and purchase of the underlying reference commodity at a price determined by the futures contract. Options and futures may be based on more generalized market indicators, such as stock indices, interest rates, futures contracts, and other derivatives.

A central counterparty-based exchange may provide for a centralized “clearing house” through which trades made must be confirmed, matched, and settled each day until offset or delivered. The clearing house may be an adjunct to an exchange, and may be an operating division of an exchange, which is responsible for settling trading accounts, clearing trades, collecting and maintaining performance bond funds, regulating delivery, and reporting trading data. One of the roles of the clearing house is to mitigate credit risk on behalf of the transacting parties as well as the exchange. Clearing is the procedure through which the clearing house becomes buyer to each seller of a futures contract, and seller to each buyer, also referred to as a novation, and reduces risk of financial loss to each transacting party due to breach of contract by assuring performance on each contract. A clearing member is a firm qualified to clear trades through the clearing house.

An exchange computer system which operates under a central counterparty model acts, e.g., using the clearing mechanism described above, as an intermediary between market participants for the transaction of financial instruments. In particular, the exchange computer system interposes itself into the transactions between the market participants, i.e., splits a given transaction between the parties into two separate transactions where the exchange computer system substitutes itself as the counterparty to each of the parties for that part of the transaction. In this way, the exchange computer system acts as a guarantor and central counterparty and there is no need for the market participants to disclose their identities to each other, or subject themselves to credit or other investigations by a potential counterparty. For example, the exchange computer system insulates one market participant from the default by another market participant. Market participants need only meet the requirements of the exchange computer system. Anonymity among the market participants further encourages a more liquid market environment as there are lower barriers to participation. The exchange computer system can accordingly offer benefits such as centralized and anonymous matching and clearing.

An interest rate futures contract, also referred to as an interest rate future, is an example of a contract traded via central counterparty based trading system and is a futures contract having an underlying instrument/asset that pays interest, for which the parties to the contract are a buyer and a seller agreeing to the future delivery of the interest bearing asset, or a contractually specified substitute. Such a futures contract permits a buyer and seller to lock in the price, or in more general terms the interest rate exposure, of the interest-bearing asset for a future date.

Currently, most IRS's are entered into on a bilateral, principal-to-principal basis, i.e. outside of an exchange (referred to as “over the counter” or “OTC”) with each ultimate counterparty being the entity with whom the other party executed the trade. As opposed to trades, such as trades in futures contracts, which are cleared via a clearing house, as described above, OTC derivatives may be booked bilaterally between the counterparties, as opposed to cleared derivatives which are booked with a clearing house. OTC bilateral derivatives counterparties, such as those involved in a IRS agreement, therefore assume credit exposure, known as counterparty credit risk, to each other while cleared derivatives counterparties are exposed to credit risk of the clearing house. Second, cleared derivatives always involve the posting of margin to the clearing house by the parties to a trade, while margining by OTC bilateral derivatives counterparties is subject to negotiation by the parties. Finally, the terms of OTC bilateral derivatives can be customized to fit the needs of the contracting parties. The terms of cleared derivatives, in contrast, typically involve a high degree of standardization to facilitate the computation of required margin amounts.

Within the interest rate swap market, bilateral netting agreements facilitate netting of positions between specific counterparties by reducing credit exposure and freeing up capital; however, it is difficult, if not impossible, for participants to freely net deals across multiple counterparties. Further, it is time consuming and cumbersome to settle each agreement separately, and there is no guarantee that the cancellation or assignment of a particular contract provides the best price.

While a central counter party-based trading system may offer certain advantages, such as anonymity and risk management, bilateral trading may still often be utilized in situations where the parties prefer not to use a central counterparty, e.g. due to cost, efficiency or other concerns, where the parties wish to complete a transaction as quickly as possible, and/or for non-standard transactions or unique transactions where the transaction terms are not standardized and/or the number of potential suitable and/or interested counter parties may be limited. For example, currency exchange transactions, such as transactions in non-deliverable currencies, foreign exchange forward or swap agreements, are typically entered into as bilateral transactions.

There may be many different markets/systems/platforms available for trading different products such as options contracts, each offering their specific products, i.e. options on particular underliers. Traders looking to achieve a particular financial goal may trade on one or more of these systems which offer the products they need. Harmonizing among these different available trading systems may facilitate trader convenience, e.g. allow a trader to readily switch among systems, and/or to draw a trader, and their business, from one system to another.

Central clearing is one way to harmonize central counter party based and OTC based trading systems and is designed to standardize certain swaps, promote transparency, and allow market participants to mitigate their counterparty credit risk to dealers. Accordingly, it is advantageous to centrally clear OTC IRS's.

As an intermediary, the Exchange bears a certain amount of risk in each transaction that takes place. To that end, risk management mechanisms protect the Exchange via the Clearing House. The Clearing House establishes clearing level performance bonds (margins) for all Exchange products and establishes minimum performance bond requirements for customers of Exchange products. A performance bond, also referred to as a margin, is the funds that must be deposited by a customer with his or her broker, by a broker with a clearing member, or by a clearing member with the Clearing House for the purpose of insuring the broker or Clearing House against loss on open futures or options contracts. This is not a partial payment on a purchase. The performance bond helps to ensure the financial integrity of brokers, clearing members, and the Exchange as a whole. The performance bond to Clearing House refers to the minimum dollar deposit which is required by the Clearing House from clearing members in accordance with their positions. Maintenance, or maintenance margin, also referred to as variation margin, refers to a sum, usually smaller than the initial performance bond, which must remain on deposit in the customer's account for any position at all times. The initial margin is the total amount of margin per contract required by the broker when a futures position is opened. A drop in funds below this level requires a deposit back to the initial margin levels (i.e., a performance bond call). If a customer's equity in any futures position drops to or under the maintenance level because of adverse price action, the broker must issue a performance bond/margin call to restore the customer's equity. A performance bond call, also referred to as a margin call, is a demand for additional funds to bring the customer's account back up to the initial performance bond level whenever adverse price movements cause the account to go below the maintenance.

Typically, the performance bond for a given portfolio is computed using a system call SPAN developed by Chicago Mercantile Exchange Inc. The CME SPAN methodology evaluates overall portfolio risk by calculating the worst possible loss that a portfolio of derivative and physical instruments might reasonably incur over a specified time period (typically one trading day). This is done by computing the gains and losses the portfolio would incur under different market conditions. In particular, SPAN establishes margin by determining what the potential worst-case loss a portfolio will sustain over a given time frame (typically set to one day), using a set of 16 hypothetical market scenarios which reflect changes to the underlying price of the future or option contract and, in the case of options, time decay and a change in implied volatility.

The main component of SPAN margin is the scanning loss. This takes a fixed set of 16 scenarios looking at moves in future prices and option volatilities, calculating a worst case loss for these scenarios.

At the core of the methodology is the CME SPAN risk array, a set of numeric values that indicate how a particular contract will gain or lose value under various conditions. Each condition is called a risk scenario. The numeric value for each risk scenario represents the gain or loss that particular contract will experience for a particular combination of price (or underlying price) change, volatility change, and decrease in time to expiration.

Exchanges and clearing organizations using the CME SPAN methodology will determine for themselves the following CME SPAN parameters, reflecting their desired degree of risk coverage:
Price scan ranges (Scan risk)—the maximum price movement reasonably likely to occur for each instrument or, for options, their underlying instrument;
Volatility scan ranges—the maximum change reasonably likely to occur for the volatility of each option's underlying price;
Intra-commodity spreading parameters—rates and rules for evaluating risk among portfolios of closely related products, for example products with particular patterns of calendar spreads;
Inter-commodity spreading parameters—rates and rules for evaluating risk offsets between related products;
Delivery (spot) risk parameters—rates and rules for evaluating the increased risk of positions in physically-deliverable products as they approach or enter their delivery period; and
Short option minimum parameters—rates and rules evaluating the irreducible minimum risk associated with portfolios of deep out-of-the-money short option positions.

At least once every business day, each exchange or clearing organization using the CME SPAN methodology calculates risk arrays for all of its products and prepares a CME SPAN risk parameter file (also called a CME SPAN array file) containing all of the above data. These files are then published to clearing firms and other market participants. Using these freely-available files and inexpensive software such as the CME PC-SPAN software, calculating a particular performance bond requirement for a portfolio is quick and easy.

The first step in calculating the SPAN requirement is to organize all positions which share the same ultimate underlying into grouping referred to as a Combined Commodity group. Next, SPAN calculates and aggregates, by like scenario, the risk of each position within a Combined Commodity, with that scenario generating the maximum theoretical loss being the Scan Risk. The 16 scenarios are determined based upon that Combined Commodity's Price Scan Range (the maximum underlying price movement likely to occur for the given timeframe) and Volatility Scan Range (the maximum implied volatility change likely to occur for options).

The CME SPAN methodology divides the instruments in each portfolio into groupings called combined commodities. Each combined commodity represents all instruments on the same ultimate underlying—for example, all futures and all options ultimately related to the S&P 500 index.

For each combined commodity in the portfolio, the CME SPAN methodology evaluates the risk factors described above, and then takes the sum of the scan risk and the intra-commodity spread charge before subtracting the inter-commodity spread credit. This sum is compared with the short option minimum (still separately for each combined commodity) and the largest between the two is taken. At this step margin values are calculated for each combined commodity. The final margin is the sum of those values (i.e. sum over all combined commodities).

As discussed, the accounts of individual members, clearing firms, and non-member customers doing business through the Exchange must be carried and guaranteed to the Clearing House by a clearing member. As described above, in every matched transaction executed through the Exchange's facilities, the Clearing House is substituted as the buyer to the seller and the seller to the buyer, with a clearing member assuming the opposite side of each transaction. The Clearing House is an operating division of the Exchange, and all rights, obligations, and/or liabilities of the Clearing House are rights, obligations, and/or liabilities of the Exchange. Clearing members assume full financial and performance responsibility for all transactions executed through them and all positions they carry. The Clearing House, dealing exclusively with clearing members, holds each clearing member accountable for every position it carries regardless of whether the position is being carried for the account of an individual member, for the account of a non-member customer, or for the clearing member's own account. Conversely, as the contra-side to every position, the Clearing House is held accountable to the clearing members for the net settlement from all transactions on which it has been substituted as provided in the Rules.

The disclosed embodiments relate to, and directly address a need in the art for, an improved computer program architecture which specifically enables an implementation of an iterative optimization process which is more efficient and features improved performance for repeatedly iteratively evaluating variations in positions allocations to determine an optimized margin value. The disclosed computer program architecture is a technical improvement which recognizes that computer programs, e.g., margin calculation systems, designed to execute infrequently and with generic data may suffer from decreased performance when executed repeatedly and/or against specific data. The computer program architecture of the disclosed embodiments is a practical application of the technical improvement which separates the functionality of an iteratively operated computer program, e.g., for computing margin values, into two parts, steps or phases, wherein in a first phase, the data to be processed is analyzed and supporting data and data structures are initialized in memory, processing steps/rules are reduced to only those applicable to the data to be processed, and, generally, those functions which need only be performed once for all iterations are completed. During the second phase of operation, only those functions which must be performed on each iteration of the computer program's operation are performed against the data to be processed. As compared with a standard computer program architecture, e.g., such as is used to compute actual margin values for portfolios, the disclosed embodiments improve the performance and efficiency of the iteratively operated computer program by reducing the amount of operations, and necessary computing resources, that must be repeatedly performed. As will be discussed, an optimization computer program is an example of a computer program which iteratively operates, e.g., by repeatedly operating on variations of a given data set until an optimal version thereof is identified, e.g., one that results in an optimal margin value.

Further, the disclosed embodiments may automate, or facilitate the automation, of the process of modifying portfolio account data structures to move data therebetween, e.g., to achieve a minimal portfolio margin value as described herein. Specifically, the disclosed technology solves a problem that uniquely arises in the fields of computer technology and exchange computer systems which compute daily margin values based on the data indicative of positions held by a trading entity at the end of each trading session, i.e., that the allocation of particular positions within the trading entity's portfolio may negatively affect the daily margin calculation but avoiding such a negative affect is computationally expensive.

The disclosed embodiments are drawn to systems and methods that include specific computing components, each being specially programmed to perform a technological function as part of a greater technological process. The disclosed embodiments include separate system components interconnected in a specific way to implement aspects of the disclosed system and include sufficient specific structure and function and, as such, are not drawn to an abstract idea.

The disclosed embodiments are not directed to any method for “obtaining, transforming and determining,” which is involved in all computing functionality. The disclosed embodiments and features recited in this regard provide numerous advantages. The instant embodiments do not preempt all methods of “obtaining, transforming, and determining,” and are specifically directed towards the disclosed functionality. The disclosed embodiments implement specific rules and features that improve the operation of a particular genus of a technological process, which does not preempt all techniques of obtaining, transforming and determining, which, at some level, is part of every computing process.

The disclosed embodiments may be implemented in a data transaction processing system that processes data items or objects, such as an exchange computer system as described in more detail below. Customer or user devices (e.g., client computers) may submit electronic data transaction request messages, e.g., inbound messages, to the data transaction processing system over a data communication network. The electronic data transaction request messages may include, for example, transaction matching parameters, such as instructions and/or values, for processing the data transaction request messages within the data transaction processing system. The instructions may be to perform transactions, e.g., buy or sell a quantity of a product at a range of values defined by equations. Products, e.g., financial instruments, or order books representing the state of an electronic marketplace for a product, may be represented as data objects within the exchange computer system. The instructions may also be conditional, e.g., buy or sell a quantity of a product at a given value if a trade for the product is executed at some other reference value. The data transaction processing system may include various specifically configured optimization and margin calculation processors that efficiently identify, e.g., automatically, position allocations as between portfolio data structures which minimize a calculated total gain or loss value.

Portfolios of positions are generally created by a trading entity to achieve a particular economic purpose of the trading entity so, in an effort to minimize margin, positions generally cannot simply be eliminated. However, those positions are obligations and therefore present a risk of loss, based on future unknown events, which must be computed accurately to collect or credit sufficient, but not more than necessary, funds to/from the trading entity so as to protect the electronic trading system with minimal burden on the trading entity. As between two portfolios held by a trading entity, each subject to a margin requirement computed according to a particular methodology, the ability to move one or more positions there between and, based thereon, increase or decrease the combined risk value varying amounts, creates a computationally intensive process to identify the allocations as between the portfolios which yields the minimal combined risk value and which may require significant computational resources and time to operate. The disclosed embodiments identify the allocation with the minimal combined risk value using minimal computational resources and time. The computer doesn't just make the process better, but the disclosed embodiments improve the computer and its ability to efficiently identify the optimal allocation using minimal resources.

In some embodiments, market and position data are used to determine the optimal allocation of IR futures and OTC IR swaps for designated accounts. In some embodiments, the CME Clearing House will provide this functionality as an “optimization tool,” which implements an optimization algorithm as described herein, which can be installed to run on a firm's back office systems. In some embodiments, the output of the optimization tool will be a set of transactions which, when executed, alter the allocation of IR Futures positions across the Listed Account (“LA”), also referred to as the segregated (“SEG”) account, data structure and a combined Listed/OTC Account data structure, referred to as the Portfolio Margining Account (“PMA”).

Recognizing the advantages to centralizing bilateral OTC and central counter party based trading, an electronic trading system in accordance with the disclosed embodiments may offer centralized clearing and risk mitigation of bilateral OTC transactions for bilateral OTC instruments using essentially the same clearing systems which are used for central counter party based transactions, referred to as listed transactions, in listed instruments. This generally enables a particular electronic trading system, e.g. such as the electronic trading system operated by the Chicago Mercantile Exchange Inc., to offer a single system where trading entities may enter into and manage positions in both bilateral OTC instruments and listed instruments.

However, legal, business and/or regulatory requirements may require that positions, e.g., the data indicative thereof, entered by a trading entity into bilateral OTC instruments be maintained, at least upon entering those positions, separate, e.g., in a separate data structure or database, from positions in listed instruments entered into by that same trading entity.

Further, current margin systems are tailored to computing margin requirements for either listed or OTC instruments but not both combined, e.g., the models which are used to compute risk of loss for listed instruments may be tailored to the characteristics of listed instruments and therefore not suitable to compute risk of loss for OTC instruments necessitating a separate model tailored for OTC instruments.

Accordingly, computing a margin requirement for a trading entity holding positions in both OTC instruments and listed instruments requires summing the separately computed margin requirements of their positions in the OTC instruments and in the listed instruments.

However, it will be appreciated that a combination of one or more positions held in an OTC instrument, such as an Interest Rate Swap (“IRS”), with one or more positions held in listed instruments, such as an IR Futures contract, may present a lower risk of loss, which, if recognized, would reduce the overall margin requirement for the trading entity.

The disclosed embodiments, which may be implemented by an electronic trading system, such as the system operated by the Chicago Mercantile Exchange Inc. (“CME”), allows trading entities, such as Clearing Members, to recognize reduced risks, and associated reduced margin requirements, resulting from offsetting open OTC positions and open listed positions for portfolios containing both products. In one embodiment, an Optimizer software tool may be offered, which maximizes benefits of margin savings and minimizes portfolio risk by suggesting offsets between swaps and listed futures.

In order to utilize the disclosed embodiments, trading entities maintain two types of accounts which are stored separately, e.g. in separate memories, data structures and/or databases. The first account is enabled to store data indicative of both OTC and listed positions, referred to as the Portfolio Margining Account (“PMA”), and the second account is enabled to store data indicative of only listed positions, referred to as the Listed Account (“LA”), also referred to as the segregated account (“SEG”). Each account is subject to a separate margin analysis using a particular margining model in order to compute the risk of loss, wherein the sum of the separately computed margin amounts represents the total margin to be collected from the trading entity for their portfolio. In particular, as will be described, the LA is analyzed using the SPAN model while the PMA is analyzed using the Historical Value at Risk (HVAR) model. For example, with respect to interest rate related instruments, the two accounts may consist of positions in listed instruments, such as ED options and futures, e.g., Futures and options on treasuries, swap futures, combos, etc., and positions in OTC instruments, such as IR swaps, fed fund swaps, swaptions, etc.

Margin (or value at risk) for a portfolio of positions is generally computed, as described elsewhere herein, by evaluating the positions in the portfolio alone and in combination under various hypothetical scenarios in order to derive an estimated risk of loss for the entire portfolio. As noted, while each position held in a portfolio may involve some risk of loss of itself, it is well known that holding multiple positions may yield a combined risk of loss that is more or less than the sum of the risk of loss of each position individually. When risk of loss of two or more positions together is less than the risk of loss of each position separately, those positions are referred to as offsetting positions. The algorithm used to evaluate the positions in the portfolio is generally tailored to the specific characteristics of the instruments in which positions may be taken and may or may not work, e.g., provide an accurate estimate for positions in other instruments. Furthermore, where positions acquired by a trading entity in different trading systems must be kept separate, e.g., in separate portfolios, the process of evaluating the positions may be limited to evaluating each portfolio separately. In this situation, offsetting positions as between the two portfolios will not be recognized and, therefore, the minimal combined margin amount for the two portfolios will not be realized.

Prior iterative optimization systems, such as the system disclosed in U.S. Patent Application Publication No. 2014/0081820 A1, herein incorporated by reference in its entirety, relied upon a number of approximations, which reduced the accuracy in finding an optimal allocation between the LA and PMA, rather than following the underlying SPAN and HVAR margin models which are what are actually used to compute the actual margin requirements, as in the disclosed embodiments. In particular, the prior optimization system, in order to improve performance, approximated the SPAN margin using a variance of the LA calculated based on historical scenarios, and utilized Delta approximation for calculating scenario profit and loss (“PNL”) for the HVAR margin of the PMA As a result, the prior system, in many cases, provided allocations that were significantly far from the true optimal solution, and in some cases would even fail in producing overall margin reduction. The disclosed embodiments are free from these disadvantages and provide a better margin savings, i.e., a more optimal lowest overall margin solution, since they truly follows the actual underlying margin calculation models but using an improved computational architectures which enables efficient repeated operation. The disclosed embodiments are generic and can be extended easily to new models. This is achieved by means of using a direct Monte Carlo optimization approach and following the underlying margin models exactly. Adding new contracts to the LA margin process is handled automatically since the disclosed Rapid SPAN process may cover all listed instruments. When adding a new instrument on the OTC side, one should not check that approximation schema is still valid, as would be the case in the old approach.

The disclosed embodiments appreciate that the HVAR model may be used to evaluate risk of loss, and compute a margin value based thereon, for combinations of Listed positions and OTC positions, in contrast to the SPAN model which is effective only for Listed positions. Accordingly, the disclosed embodiments enable a trading entity to move Listed positions between the LA and the PMA in an effort achieve additional offsets which may lower the overall margin requirement as will be described. As the SPAN model is not designed to evaluate both Listed positions and OTC positions, the disclosed embodiments do not allow OTC positions to be moved between the LA and PMA. Generally then, the disclosed embodiments relate to determining an optimal allocation of the Listed positions held by trading entity as between the LA, where they would be subject to SPAN and considered only in combination with the other Listed positions therein, and the PMA, where they would be subject to HVAR and considered in combination with both the Listed and OTC positions therein, so as to realize the lowest overall margin requirement.

As used herein, a position, whether a Listed position or an OTC position, refers to a contractual position entered into with respect to a unit quantity of a particular instrument. For example, if a trader holds a long position in five of the same futures contracts, that would be considered five positions, any or all of which, assuming they are Listed positions, can be transferred between the LA and PMA as described herein. With regards to a particular Listed or OTC contract or product, the number of positions held in that contract, e.g., the quantity of that contract/product held, may be referred to as the “weight” or a “weighting” where the transfer of some or all positions of a given Listed contract/product between the LA and PMA may be referred to as a change in weight/weighting of that particular contract/product as allocated between the LA and PMA, and may be designated as a percentage, a magnitude or a delta (net change), etc. The initial distribution, or resultant re-distribution, of a set of Listed positions among the LA and PMA may be referred to as an “allocation” and a hypothesized allocation, for the purpose determining the effect of particular distribution of Listed positions on overall margin before actually modifying the portfolio, may be referred to as a hypothetical allocation or an allocation scenario.

In accordance with the disclosed embodiments, a trading entity can transfer particular listed positions between the LA and PMA, i.e., from the LA to the PMA or from the PMA (there due to a prior move) to the LA, in order to achieve margin capital efficiency, i.e., to minimize the overall margin requirement for their portfolio. By moving Listed positions to or from the LA from or to the PMA, the margin values of the LA and/or PMA, due the presence or absence of offsetting positions, will change, e.g., one or both may go up and/or down by the same or different amounts, possibly resulting in a net change to the overall margin for the portfolio, either a net increase or net decrease.

However, determining which one or more listed positions to move into or out of the PMA in order to minimize an overall margin requirement is complex and it may not always be apparent, without a complete encyclopedic knowledge of the SPAN and HVAR models, which positions, e.g., in which instruments and how many, in which combinations will achieve the minimal margin requirement. In other words, the effect of transferring Listed positions between the LA and PMA cannot be readily anticipated without actually testing the modified LA and PMA to calculate the margin values, and the minimal margin may not be readily determined without comparing those results with the results of other tests.

One way in which to determine which listed positions to transfer is via brute force—namely, by trying all possible combinations of transfers, computing the total margin, and selecting the lowest. However, the computational time associated with such a brute force method can be enormous for large portfolios and for precise calculations. Thus, in some embodiments, an optimization algorithm in accordance with the present teachings approximates margin values for iteratively varied position allocations in order to calculate proposed transfers more quickly.

In particular, any Clearing Member that wishes to clear both OTC IRS and IR futures must undertake a multi-step manual process to achieve margin efficiencies across these two sets of products. This manual process must be repeated for each entity related to, or whose positions are cleared by, the clearing member. A Clearing House is actually composed of two silos—an OTC silo, i.e., the PMA, and a Listed silo, i.e., the LA, —and, desirably according to the disclosed embodiments, listed positions will optimally be allocated across both silos.

Additionally, there are negative consequences associated with misallocating listed positions across the two accounts. In fact, if done improperly, misallocating listed positions can result in higher margins than the base case (i.e., futures margined by themselves and swaps margined by themselves). The current solutions do not properly scale in such a way that they can be extended to thousands of accounts in a fully automated way on a daily basis (or more frequently if desired).

For example, current mechanisms will typically employ a business analyst for data aggregation, a quantitative analyst for computing optimized allocation of futures positions, and an operations analyst for inputting the resulting transfers into a graphical user interface (GUI). Due to the substantial overhead associated with current mechanisms such as this, an end user generally cannot optimize/rebalance a portfolio on a daily basis, thereby forgoing potential savings. In addition, the entry of transfers into the GUI by the operations analyst is susceptible to human user error (e.g., omission, mis-keys, etc.). Moreover, the operations analyst will typically have to enter both sides of any transfer trade (e.g., the buy transaction and the offsetting sell transaction) into the GUI for potentially dozens of contracts. Each side of the transaction can take approximately 30 seconds, which—from the point of view of trade processing alone—will correspond to about one minute per contract. Thus, without proper automation, only an extremely small subset of the universe of entities participating in these two markets would be able to realize initial margin capital efficiencies.

By contrast to current mechanisms, an optimization tool in accordance with the present teachings, as further described herein, can be used for automatically generating transfer messages that can be sent to, by way of example, CME Clearing's trade processing system and accurately processed in a matter of seconds. Clearly, automation in accordance with the present teachings can result in significant savings in man-hours, particularly when scaled up to hundreds or thousands of portfolios. Moreover, an optimization tool in accordance with the present teachings can ensure accuracy of the transfers by programmatically generating them according to the results of the disclosed optimization as opposed to relying upon entry of the transfers into a GUI by an operations analyst which, as noted above, is susceptible to human user error.

In some embodiments, the accuracy and speed of initial margin balancing across multiple accounts/products is improved. As some Clearing Houses, such as the Clearing House of the CME, referred to as “CME Clearing,” may support customer Portfolio Margining (PM), traders and/or trading firms (referred to herein as “firms”) may desire an “optimization tool” that can perform functions as described below.

The disclosed embodiments provide an enhanced optimization tool that significantly improves the performance efficiency and ensures the margin values used to determine the optimal allocation of listed positions are in accordance with the margins as computed and charged by CME.

As noted above, one method for determining an optimal allocation of Listed positions as between the LA and PMA is to use brute force. For example, one may simply use the SPAN, e.g. PC SPAN, and HVAR models, to compute the margin requirements for each allocation scenario until the optimal scenario is determined. However, in addition to the potential large number of allocation scenarios (hypothetical iterative variations of the Listed position allocations between the LA and PMA) that would need to be tested as described above, the SPAN and HVAR models are complex software programs designed to be executed infrequently, e.g. no more than once or twice per day, on any given portfolio of positions/products, e.g., they are designed to handle all possible position/product combinations available from the electronic trading system that a trading entity may hold. These programs evaluate any given portfolio against a complex and large set of pre-defined portfolio-generic rules and parameters determined at the time of execution, in a manner which is specifically configured and optimized for singular application to any given portfolio, i.e. to the actual allocations of the Listed positions.

In particular, the disclosed embodiments recognize that the actual SPAN and HVAR algorithms are complex and resource intensive processes and, while it is efficient and effective, and in fact necessary, to run those processes infrequently, e.g. once or twice per trading day, to compute actual margin values, it would be inefficient to try to run them repeatedly, e.g., using the iterative optimization process described herein.

Accordingly, as will be described, the disclosed embodiments use alternative algorithms to the actual SPAN and HVAR algorithms which are more computationally efficient and can be run repeatedly within a limited time frame and with reduced computational resources. In one embodiment, the particular margin values computed by the disclosed embodiments may not be identical to the values which would be computed by the actual SPAN and HVAR algorithms, but the relationship between the computed values as resulting in a higher or lower overall margin for the portfolio will be accurate. That is, the disclosed embodiments can identify the allocation of IR Futures across the LA and PMA which achieves the minimal overall margin for the portfolio without computing the actual margin value which would be computed by the SPAN and HVAR algorithms.

Generally, the disclosed embodiments implement a computer program architecture which distinguishes between those functions performed by the SPAN and HVAR models which must be performed on each allocation scenario to be tested from those functions which need only be performed once for all of the allocation scenarios to be tested. In contrast, using SPAN or HVAR in a brute force manner to determine an optimized allocation would require that all of the functions of SPAN and HVAR be repeated for each scenario to be tested which, due to their computationally intensive nature, would result in significant consumption of computing resources and, for a large number of scenarios, take a considerable amount of time. In the typical application of SPAN and HVAR to, for example, compute a daily margin requirement, the execution of these models only once for a given portfolio does not suffer from such performance degradation.

Accordingly, whereas SPAN and HVAR essentially implement a single step operation in which all of the necessary functions are performed when evaluating a given portfolio, the disclosed embodiments implements a two-step process where the functions that need only be performed once are separately performed only once during a first-initialization step/phase and the allocation-scenario-specific functions are then repeatedly performed for each proposed allocation scenario during a second-optimization step/phase. This advantageously avoids the unnecessary repeated processing of those functions which need not be performed more than one time for a given portfolio, as will be described. In addition, the allocation-scenario-specific functions are further optimized for efficient operation, e.g., by using relaxed rounding requirements, etc. As described above, in one embodiment, it may not be critical that the disclosed embodiments compute an accurate margin value for each allocation scenario but that, relative to the margin values computed for each allocation scenario, the allocation scenario with the lowest margin value may be identified.

In particular, according to the disclosed embodiments:
Let notations be
   Present listed positions: P_{L} (it will be appreciated that initially, i.e., at time zero, all Listed positions will be in the LA, because upon creation of such a position, it must be stored in the LA, but as the disclosed embodiments are used to optimize the portfolio over time, a given portfolio for optimization may begin the optimization process with some listed positions in the PMA and some in LA as a result of a prior use of the disclosed optimization system. It is possible that at the outset of the application of the disclosed optimization process, there may be no Listed positions in the LA as they are either all currently in the PMA due to prior operation of the disclosed embodiments or because the trading entity has no Listed positions, e.g., they never had any or they closed out what they had).
   Present positions in PMA account: P_{PM} (it will be appreciated that a given PMA at the outset of the optimization process may have no Listed Positions, e.g., because they are all in the LA or there are none, and/or no OTC positions because there are none).
   Let margins of LA and PMA be M_{L} (P_{L}) and
   M_{PM} (P_{PM}) respectively.
   Offsets (transfers) to/from the LA from/to the PMA account are denoted as: Pₒ
The total margin before optimization is

M_{Total}=M_{L}(P_{L})+M_{PM}(P_{PM})
Margin after a specific transfer, Pₒ, becomes

M=M_{L}(P_{L}−Pₒ)+M_{PM}(P_{PM}+Pₒ)
Optimization goal is to minimize the total margin, M, with respect to offsets Pₒ.
Offsets are subject to natural boundary conditions:
   For each product one cannot transfer more positions than present in the LA.
   Same applies to back transfers from the PMA to the LA, i.e., one cannot transfer more positions from the PMA to the LA than originally present in the PMA.

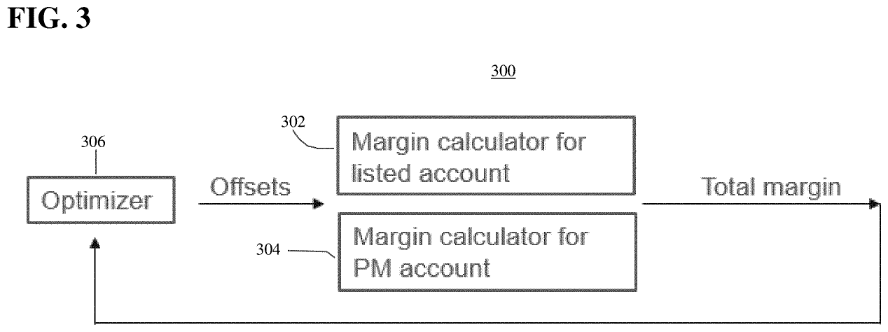

As shown in FIG. 3, the disclosed embodiments may be implemented as an enhanced optimization tool 300 that improves the performance and efficiency of the optimization process significantly and ensures the numbers are accurate to the margins as charged by CME. The tool, according to the disclosed embodiments, includes the following three components:
An LA margin processor component 302 for efficient calculation of margin of LA's in accordance with the SPAN model;
An OTC margin processor component 304 for efficient calculation of margin for PMA's in accordance with the HVAR model; and
An optimization processor/margin minimizing processor 306 that iteratively computes and applies, to in initial portfolio (LA and PMA position configuration/allocation scenario), different offsets, to create different allocation scenarios, continuously until it reaches the set of positions, i.e., an allocation scenario, in the accounts that has the lowest possible/optimized margin amount, after which the set of offsets, i.e., transactions, necessary to transform the initial portfolio into the configuration with that optimized margin amount, is output in a manner which allows a user to programmatically apply the changes to actually alter the allocations in their portfolio to realize that optimal margin or otherwise to enable an automated system to apply the changes.

The disclosed embodiments may be subject to the following technical requirements:
Margins values of both accounts must be calculated accurately enough to ensure sufficient capital efficiency, i.e., that the portfolio configuration with the lowest total margin may be determined even if the actual margin amount are not determined.
The disclosed optimization processor must be capable of finding a global minimum reliably.
The disclosed embodiments must be numerically efficient enough to process a large number of accounts on a single (or just few) computer nodes.

It will be appreciated that SPAN margin is difficult to approximate in a reliable way. To achieve sufficient margin computation accuracy, the SPAN algorithm should be followed closely but the actual SPAN algorithm cannot be implemented efficiently for repeated execution, as was described above. Similarly, to satisfy accuracy requirements, one has to follow HVAR model rather closely. Further, a merit function (total margin) is not a smooth function, in particular due to the rule based nature of the SPAN model, i.e., a set of successive linear or incremental inputs may result in non-linear/non-incremental outputs For example, for incremental/successive small variations in position allocations, one variation may trigger application of a rule which result in large, e.g., non-linear, variation in the resultant margin value as compared to the effect of the preceding or succeeding variations which may not trigger that same rule. Thus, the optimization processor must be tolerant to the roughness of the merit function, and yet numerically efficient.

In summary, for computing the margin of the LA, the disclosed embodiments follow the logic of the SPAN model closely thereby ensuring the accuracy of the margin calculation. However, efficiency is achieved by means of an innovative approach, i.e., use an improved computer program architecture, to the SPAN algorithm implementation, referred to herein as “Rapid SPAN”, utilizing a number of improvements to speed up the performance, as will be described. With regards to the margin of the PMA, the disclosed embodiments follow the OTC HVAR model closely. For the PMA, efficiency is achieved via use of the improved computer program architecture described herein to implement pre calculation of scenario profit and loss values (“PNL” 's) and by using an optimized HVAR calculation, referred to herein as “Fast HVAR.”

With regards to the optimization processor, the disclosed embodiments use a direct Monte Carlo optimization rather than a deterministic optimizer algorithm such as steepest decent. This ensures protection against roughness of the optimization merit function. In one embodiment, the optimization processor uses a Differential Evolution optimizer algorithm with a low (approximately 20) population, e.g., candidate allocation scenarios, which has been shown to be effective for most portfolios.

In evolutionary computation, differential evolution (DE) is a method that optimizes a problem by iteratively trying to improve a candidate solution with regard to a given measure of quality, i.e., a merit function which in the disclosed embodiments is a margin value which is the lowest for all possible allocation scenarios. Such methods are commonly known as metaheuristics as they make few or no assumptions about the problem being optimized and can search very large spaces of candidate solutions. However, metaheuristics such as DE do not guarantee an optimal solution is ever found. DE is used for multidimensional real-valued functions but does not use the gradient of the problem being optimized, which means DE does not require the optimization problem to be differentiable, as is required by classic optimization methods such as gradient descent and quasi-newton methods. DE can therefore also be used on optimization problems that are rough, e.g., not even continuous, are noisy, change over time, etc. DE optimizes a problem by maintaining a population of candidate solutions and creating new candidate solutions by combining existing ones according to its simple formulae, and then keeping whichever candidate solution has the best score or fitness on the optimization problem at hand. In this way the optimization problem is treated as a black box that merely provides a measure of quality given a candidate solution and the gradient is therefore not needed.

According to at least one embodiment of Rapid SPAN, the following definitions apply:
Combined commodity (“CC”) is a group of products that share the same or similar underlying, e.g., same underlying commodity or instrument for a futures or options contract.
Intra commodity tiers are groups of consecutive period codes (codes which identify the expiration date/month/time frame of a given instrument) defined for each CC. Used for formation on intra CC Delta ladders (“DL”).
A DL is the change of an interest rate swap portfolio value given a 1 basis point (0.01%) change to the underlying.
Inter commodity tiers are groups of consecutive period codes defined for each CC. Used for formation on inter CC DL's.
Risk arrays and Delta ladders:
   Risk array (16 scenarios) per each CC.
   Delta array on the period code level.
   Delta array defined on the level of intra CC tiers.
   Delta array defined on the level of inter CC tiers.
Spread rules:
   Intra CC spread rules are predefined rules that are applied to intra CC DL. Applied separately within each CC group. Applying each spread consumes Delta and generates intra CC charge.
   Inter CC spread rules are predefined rules that are applied to inter CC DL's that belong to different CC classes. Applying each spread consumes Delta and generates inter CC credit.

Generally, the margin amount M of an account, as computed by the SPAN algorithm, is given by the sum over all combined commodities present in the account with each CC contribution being the sum of three terms:

$$M = {\sum }_{c} {M}_{c}^{( Scan )} + {C}_{c}^{( Intra )} - {C}_{c}^{( Inter )}$$

A scanning margin, M_{c}^{(Scan)} is calculated over 16 scenarios applied homogeneously (in parallel) within each combined commodity. Intra commodity charge, C_{c}^{(Intra)}, is obtained by means of applying spread charges to the intra commodity Delta ladder and is responsible for providing non-zero margin to positions with zero net Delta (spreads, butterflies, etc.). Inter commodity credit, C_{c}^{(Inter)}, provides margin offsets between correlated combined commodities and is obtained by means of applying inter commodity spread credits to the remaining (after applying intra commodity spreads) Delta ladder. Single combined commodity margin is floored with the minimal short option value contribution (or zero).

Rapid SPAN, according to the disclosed embodiments, in order to achieve high efficiency, defines the products that constitute listed portfolio so that they are known in advance, i.e. during the initialization step and prior to the optimization step. Accordingly, only the position amounts/allocations of those products are varied during the optimization process. Accordingly, the margin calculation process is then broken into two parts:
Initialization step/phase which is performed once per optimization session. As this step is performed only once for the optimization process, it need not, but may, be optimized; and
Unit optimization step/phase where margin is calculated per specific position amounts, i.e., repeated for each allocation scenario. The disclosed embodiments optimize this step utilizing precalculated data on the initialization step so that it may be efficiently repeated for each allocation scenario.

According to the disclosed embodiments, the following data is set on the initialization step:
Only CCs that are present in LA are considered. In particular, the LA is reviewed to determine the CC's present therein;
Values of risk arrays and Deltas are set for each product for which a Listed position is held in the LA and stored in memory;
Period code Delta arrays are preinitialized. Only those period codes that are present in the LA are arranged and stored in memory;
Intra and inter commodity DL's are arranged in memory with zero values, i.e., to be later populated;
Intra CC rules are prefiltered and initialized in memory. Only those rules that can be potentially applied to the actual positions in the LA are kept (based on present products and period codes);
Inter CC rules are pre filtered and initialized in the memory. Only those rules that can be potentially applied to the actual positions in the LA are kept (based on present products and period codes); and
Short option minimum charge for each product is arranged in memory.

As will be appreciated, the arrangement/storage of data and/or data structures (to be later populated with data) in memory includes pre-allocating, e.g., using direct memory management, computer memory designated to store the data and/or data structure prior to the optimization step. Allocation of memory is computationally expensive and, therefore, by pre-allocating the memory and storing data and/or data structures therein, which will be used by the optimization step, in advance thereof, performance may be improved.

The Rapid SPAN calculation flow performed on each iteration, i.e., for each allocation scenario, of the optimization process, according to the disclosed embodiments, is:
For each CC, calculate a risk array by performing summation of pre calculated risk arrays of products with coefficients given by product positions and calculate the scanning risk contribution to the margin;
Calculate, utilizing the contract deltas prearranged during initialization, initial DL's for each CC including DL's defined on the levels of period codes, intra CC tiers, and inter CC tiers;
For each CC, apply all intra CC spread rules that were prearranged during the initialization step. This sub-step is ceased in the DL turns one sided.
Update all DL's on each application of a spread rule. Calculate intra CC charge per each CC;
Apply all inter CC spread rules that were prearranged during the initialization step, consuming intra CC Delta on each application. Calculate inter CC credit;
Calculate short option minimum per each CC;
Calculate SPAN risk within each CC as:

M_{c}=max(C_{c}^{(Scan)}+C_{c}^{(Intra)}−C_{c}^{(Inter)},SOM); and
Calculate the total margin

$$M = {\sum }_{c} {M}_{c}$$

Similar to SPAN, the standard implementation of the HVAR algorithm is designed to calculate margin of the PMA infrequently, e.g., once per each account such as for intra-day or daily margin, as a single operation, i.e., the HVAR process need not be pre-initialized based on the positions/products in the account to be processed as the process is only effectively executed once. In the standard HVAR process, the most computationally expensive part of the algorithm is the calculation of each of the scenario PNL's and Deltas of the OTC trades and listed contracts in the PMA. Furthermore, the step of calculating HVAR from the calculated account scenario PNL's and Deltas does not bottleneck the whole algorithm when executing only once for a given portfolio, and, thus, does not require an efficient implementation.

In the Fast HVAR of the disclosed embodiments, the HVAR process is optimized similar to Rapid SPAN, i.e., by initially calculating and storing in memory the PNL's and Deltas of all trades and contracts in the PMA during an initialization step which precedes the iterative optimization process (the optimization step). Additionally, the scenario PNL's of the OTC positions in the PMA can be summed up during the initialization step as the OTC positions will not be moved to/from the PMA during the optimization step. Only the Listed positions are changed during each optimization iteration. However, for repeated application of the HVAR process, the calculation of HVAR margin from the scenario PNL's and Deltas now becomes a bottleneck of the optimization process that impacts optimizer performance.

The Fast HVAR algorithm, according to the disclosed embodiments, addresses the calculation of HVAR margin from the scenario PNL's and Deltas using a fast quantile calculation. In contrast to the standard algorithm for quantile calculation which consists of ordering scenario PNL's and taking a loss value according to the quantile value, the Fast HVAR algorithm performs an optimized PNL's ordering algorithm where only a few scenarios, that can potentially affect value at risk (“VAR”) are kept track of. Computational complexity of a standard high-performance sorting algorithm, such as, for example, merge sort is ˜Nₛ log (Nₛ) where Nₛ is the number of elements to be sorted, that in the case of the disclosed embodiments is the number of scenarios. The computational complexity of the Fast HVAR algorithm is ˜Nₛ log (N_{w}), where N_{w} is the number of worse case scenarios that need to be tracked. The computational complexity of the Fast HVAR is lower than that of standard sorting algorithm because N_{w} is usually significantly less than Nₛ. For example, in the setup with 1000 scenarios and 99.7% quantile, the algorithm will keep track only of 1000*(1−0.997)=3 worse scenarios. The Fast HVAR algorithm consists of iterating over all scenario PNL's and updating the ordered set of worse scenarios on each step. The computational cost of each update is log (Nₛ), multiplying it by the number of iterations, Nₛ, the above stated computational performance complexity of the Fast HVAR algorithm is obtained.

More particularly, the Fast HVAR process, according to the disclosed embodiments, comprises a fast implementation of the HVAR algorithm where the HVAR framework is characterized by:
Historical returns of underlying risk factors which are used in order to generate risk scenarios;
Often historical returns are processed with the help of a time series model in order to scale historical returns to the current market conditions;
Portfolio scenario profit and losses (“PNL”s) are calculated by means of bumping risk factors and repricing the portfolio. Portfolio PNL is the sum of individual contracts PNL's:

$${PNL}^{s} = {\sum }_{i} {c}_{i} {PNL}_{i}^{s}$$

Here PNLᵢ^{s} is the PNL of s-th scenario of i-th contact in PM account. The coefficient cᵢ is the amount of i-th contact in PM account. Scenario PNL of a contact is calculated by evaluating the contact at bumped market (for a given scenario) and at the base (unperturbed market) level and subtracting the two. The coefficients cᵢ of OTC contacts are all equal 1 and do not change within optimization process. The coefficients cᵢ of listed contracts do change within optimization process. Contact scenario PNL's, PNLᵢ^{s} do not change within optimization process, and, thus, can be calculated prior to the optimization session. Margin is calculated as a percentile (usually 99.7%) of portfolio scenario percentile.

According to the disclosed embodiments, the Fast HVAR process uses an efficient implementation wherein:
Scenario PNL's for the OTC positions in the PMA, as described above, are pre-calculated on the account level since OTC trades are not moved between the PMA and LA during optimization and scenario PNL's of those contracts are taken with unit coefficients;
Scenario PNL's for the listed products in the PMA are pre-calculated for each contract;
Full PMA scenarios PNL's are calculated as a sum of OTC scenarios PNLs (pre-summed with unit coefficients) which are scenario PNLs of listed products taken with coefficients suggested by a numerical optimizer on each optimization step; and
Quantile (cut points dividing the range of a probability distribution into continuous intervals with equal probabilities, or dividing the observations in a sample in the same way.) is calculated by means of the efficient fast quantile algorithm, described above, that keeps tracks of only necessary amount of worst case scenarios.

In addition to the initial margin computed by the Fast HVAR process, referred to as the “Market Risk” charge, a “Liquidity Charge” or component may be added where the total margin for the PMA is the sum of the Market Risk and Liquidity Charge. IRS products' portfolios that present significant liquidation risk within the margin period of risk are subject to the liquidity/concentration add-on. For medium to large portfolios that could pose significant liquidity risk, the add-on prudently accounts for the cost of hedging and auctioning a directional or hedged IRS products' portfolio under a stressed market environment. Liquidity is calibrated to the portfolio greeks. In one embodiment, the Liquidity Charge/component is computed as described in U.S. patent application Ser. No. 14/457,680, published as U.S. Patent Application No. 2016/0048921 A1, entitled “INTEREST RATE SWAP AND SWAPTION LIQUIDATION SYSTEM AND METHOD”, which is herein incorporated by reference in its entirety.

Regarding the optimization processor, according to the disclosed embodiments, the optimization processor:
cannot rely on the smoothness of the merit function. That excludes methods like gradient descent, conjugate gradients, Levenberg-Marquardt, etc.;
should not get stuck in local minima (traps); and
should converge reasonably fast to the global minimum (most optimal solution) in most of the cases.

The disclosed embodiments utilize a Differential Evolution (“DE”) optimizer to satisfy the above requirements. A DE optimizer:
does not attempt to calculate gradient of the merit function and, thus, is tolerant to rough merit function surfaces;
never get trapped in local minima;
is effective at low population numbers; and
is shown, via numerical experimentation, to demonstrate good solver convergence even at low population numbers (˜20).

In one embodiment, the disclosed optimizer tool runs at the end of the trading day (“EOD”) and goes through a large number of accounts in the least possible time and provides offset suggestions which results in the best possible and accurate margin requirements for the customer. For a given account the optimization process stops if either an optimal solution is reached, or if the number of iteration exceeds certain configurable maximally allowed value, e.g., an iteration threshold. In an alternative embodiment, the optimization may stop when a difference in computed margin value between successive optimization iterations falls below a threshold value wherein the threshold value may represent a threshold of diminishing returns and be defined based on a relationship between margin savings and the computational resources needed to be expended to obtain such savings. It will be appreciated that, as used herein, the optimized or optimal margin value for a given portfolio is the value that is determined by the disclosed system but may not necessarily be lowest possible margin amount (or maximum margin credit).

By way of introduction, in some embodiments, a process for minimizing a margin requirement of a trader holding first and second accounts, i.e. an LA and a PMA as described above, the first and second accounts being characterized by a combined margin requirement, comprises the following acts: (1) receiving data representative of a first plurality of positions in the first account and a second plurality of positions in the second account; (2) determining an optimal reallocation of the first and second plurality of positions between the first and second accounts which results in a total margin requirement for the first and second accounts that is less than the combined margin requirement and/or lowest of all possible reallocations; (3) determining one or more modifications to the plurality of positions of the first account, the second account, or a combination thereof to achieve the determined optimal reallocation; and (4) generating a set of proposed transactions to effect the determined one or more modifications. In some embodiments, the process for minimizing a margin requirement as described above is implementable by an optimization tool, as further described below. In one embodiment, the set of proposed transactions is generated in an electronic form which may be, or is, automatically provided to an electronic trading system, or computer implemented clearing system thereof, to effect the changes to the first and second accounts.

In act (1) of a method in accordance with the present teachings, data representative of a first plurality of positions in the first account and a second plurality of positions in the second account are received (e.g., in a single system). All relevant data elements (e.g., such as market and position data provided by firms) can be gathered and loaded into a single system (e.g., an optimization tool). These data elements can include but are not limited to the delta ladder file, Standard Portfolio Analysis of Risk (SPAN) file, futures position file, base curve file, scenario PNL per listed product file, or the like, and combinations thereof. Some of the data files that may be needed for proper processing are summarized in Table 1 below. In some embodiments, the optimization tool receives—vis-á-vis the “futures position file”—the customer's regular futures positions residing in a 4(d) account, the customer's swap and futures positions residing in a Portfolio Margin 4(d)(f) account, and a mapping table that maps 4(d), 4(d)(f) and delta ladders together by client.

TABLE 1

| | |
|---|---|
| Delta Ladder | This file may be generated on a nightly basis from |
| | the CME IRS back-office processing system. A |
| | delta ladder is an IRS portfolio expression of risk to |
| | the optimization tool for a given performance bond |
| | (“PB”) account (client). One-to-many curves per PB |
| | account will be created within each delta ladder file. |
| Composite | This file contains the composite delta and settlement |
| Delta/SPAN | price statistics for every active Eurodollar and |
| | Treasury futures/options contract that may be |
| | contained within a client's portfolio. |
| Scaled Log | This file is a data file created nightly from the CME |
| Returns | IRS back-office processing system that is used as |
| | part of the margin/savings approximation process in |
| | the algorithm |
| Base Curve | This file contains the base curves, FX rates, futures |
| | data, and pricing used by the optimization tool to |
| | calculate risk offsets of Eurodollar and Treasury |
| | futures against IRS. |
| Positions | This file contains the current allocation of futures |
| | within a client's PM account and futures/options |
| | contracts contained within the segregated (SEG) |
| | account. This file may also link each PM and SEG |
| | account back to their corresponding PB account. |
| | There may be only 1 PMA per PB account and only |
| | 1 LA per PB account. |

In some embodiments, the market data, to be loaded into an optimization tool in accordance with the present teachings, can include but are not limited to delta ladder per performance bond (PB) account (client) sent from the CALYPSO® (i.e., the OTC clearing application), composite delta for every active Eurodollar and Treasury option contract which may be parsed from a SPAN file, current settlement prices for eligible futures contracts which may be parsed from a SPAN file, prior day settlement prices for eligible futures contracts which may be parsed from a SPAN file, scaled log return file, base curve file, or the like, and combinations thereof. In some embodiments, the data can include but are not limited to data representative of an expression of risk for a margin account of the trader, composite delta statistics for every position which may be contained in the first account, OTC IRS data from an OTC IRS clearing system, base curves, foreign exchange rates, futures data and pricing for computation of risk offsets of Eurodollar and Treasury futures, a current allocation of futures within a PMA and futures/options contracts within the LA (futures position segregated account), or the like, and combinations thereof. In some embodiments, when the first account comprises an interest rate futures account, the positions therein can include Eurodollar futures, Eurodollar options, Treasury futures, Treasury options, or the like, and combinations thereof.

In some embodiments, CME can post all relevant input data to a CME FTP site. Clearing members can pull in data—which can include the delta ladder file, span file, futures position file, base curve file, scaled log return file, and/or the like—from the CME FTP site. By way of example, position and input data loaded into the CME optimization tool can include but are not limited to customer's regular futures positions residing in a 4(d) account (Eurodollars need to be longs and shorts by contract; Treasuries need to be longs and shorts by trade date by contract), futures positions residing in a PM 4(d)f account, and other input data from CME FTP sites.

Upon being launched, the optimization tool can sweep the specified input directory for the data files to process. The location of the input directory may be specified within a configuration file.

In act (2) of a method in accordance with the present teachings, an optimal reallocation of the first and second plurality of positions between the first and second accounts, which results in a total margin requirement for the first and second accounts that is less than the combined margin requirement and/or lowest of all possible reallocations, is determined. In some embodiments, the optimal reallocation comprises determining the optimal allocation of interest rate futures across an entity's swaps account and futures account. In some embodiments, an optimization algorithm in accordance with the present teachings can be run for each portfolio to determine the optimal allocation of interest rate futures positions across two accounts. In contrast to the disclosed embodiments, the optimization algorithm, in prior systems, was implemented using a measure of volatility as a sufficient proxy for initial margin to determine the optimal allocation.

In some embodiments, the optimization tool will identify the optimal allocation of available cross-margin opportunities. Once the data are read into the optimization tool and parsed, the optimization tool may process the data and calculate what transfers (if any) can be made to improve the allocation of futures across the LA and PMA to take advantage of the Exchange's portfolio margining program. The optimization tool may be capable of processing multiple portfolios (associated PMA's and LA's) in batch. Thus, multiple portfolios may be represented in the delta ladder and positions input files.

In act (3) of a method in accordance with the present teachings, one or more modifications to the plurality of positions of the first account, the second account, or a combination thereof that will achieve the determined optimal reallocation are themselves determined. In some embodiments, the net change needed to change each position in each account to match the optimal allocation is deduced. Given the result from act (2) and the initial allocation of positions from act (1), the net positions to transfer to and from each account for each contract for each client can be deduced. In some embodiments, the optimization tool can deduce the net change in each contract to be transferred (e.g., net contract for Eurodollars and Treasuries).

In act (4) of a method in accordance with the present teachings, a set of proposed transactions to effect the determined one or more modifications are generated. Once the optimal allocation of futures has been found, transfer messages to rebalance the relative positions on the books of the Clearing House can be created. In some embodiments, the transfer message comprises a FIXML transfer message. In some embodiments, the optimization tool will output 2 files: a .csv summary file to summarize the changes that took place and a FIXML file containing associated transfer messages to effect the changes from act (3) on the clearing house's books.

In some embodiments, the optimization tool will generate a comma separated value (.csv) file and a text (.txt) file (e.g., FIXML) with transfer messages that may be used by the clearing member firm to process transfers, which may require contract trade dates. In some embodiments, the optimization tool creates FIXML transfer messages which can be sent to an electronic trading system, such as that operated by the Chicago Mercantile Exchange, such as via a message queue (“MQ”) (or other communication methods) to a front end clearing system (“FEC”). In such embodiments, the firms will already have setup their systems to send the FIXML messages to the Exchange (e.g., CME) via MQ. In some embodiments, transfers are automatically executed in FEC. In some embodiments, FIXML confirmations are sent to clearing member back office.

In some embodiments, there will be one .csv and one FIXML file created per execution of the optimization tool. By way of example, if the delta ladder and positions files contain five separate portfolios within them, there will be a single .csv and FIXML output containing optimized position allocations for five portfolios. In some embodiments, the FIXML file is in a format ready to be sent to the Exchange (e.g., CME) for clearing.

In some embodiments, an optimization software application—which may be installed to run on a firm's back office systems, thereby creating a substantial cost savings—is provided. This new tool may allow exchanges, such as CME, to ensure that customers can achieve the most margin savings through the PM offering.

In some embodiments, firms may be responsible for providing the optimization tool with the proper inputs and sending the FIXML transfer messages to CME Clearing (as well as installing the optimization tool to run on their back office systems). In some embodiments, the Exchange may only be responsible for executing transfers after receiving the firms' instructions.

In some embodiments, for each participating customer of the Exchange in the portfolio margining program, the disclosed embodiments may further be able to house position level data including but not limited to: trade level details for each contract residing in the customer's PMA, such as position, original trade date, and original trade price; and trade level details for each Treasury (2, 5, 10, Bond) and Eurodollar futures and options contracts residing in the customer's LA, such as position, original trade date, and original trade price.

For each customer participating in the portfolio margining program, the optimization algorithm in accordance with the present teachings, described in more detail below, may have the ability to identify the total long positions in each eligible futures contract and/or total short positions in each eligible futures contract. Furthermore, the algorithm may have the ability to solve for the optimal net position in each eligible futures contract where the customer has positions (e.g., total long and short positions in each eligible futures contract).

In some embodiments, users can configure transfer assumptions by product. A first configuration comprises original trade date and/or current trade date depending on the contract. A second configuration comprises original trade price and/or current day settle depending on the contract. A third configuration comprises FIFO (First In, First Out) or LIFO (Last In, First Out), thus deducing not only the net position but also the precise trades to move for a given contract based on their date of execution.

In some embodiments, an exemplary Transfer Add Message to the Exchange (e.g. CME) may take the following form when initiating a trade transfer via a suitable application program interface (API): add transfer (TrdTyp=“3”) with original trade date (OrigTrdDt) and Transfer Reason Code (OrdTyp)=“M”:

<FIXML>
<TrdCaptRpt MsgEvtSrc=″API″ TrdHandlInst=″0″ RptID=″0012217″
TransTyp=″3″ TxnTm=″2012-02-27T09:06:23-06:00″ TrdDt=″2012-02-
27″ BizDt=″2012-02-27″ RptTyp=″0″ MLegRptTyp=″1″ TrdTyp=″3″
OrigTrdDt=″2012-02-24″ LastQty=″75.00″ LastPx=″98.82000000″
TrdID=″0010099″>
<Hdr Snt=″2012-02-27T09:06:23-06:00″ SSub=″CME″ TSub=″CME″
SID=″999″ TID=″CME″/>
<Instrmt Exch=″CME″ ID=″ED″ CFI=″FXXXXX″ MMY=″201412″
SeeTyp=″FUT″/>
<RptSide CustCpcty=″2″ Side=″1″ ClOrdID=″0059″ SesID=″RTH″
InptDev=″API″ OrdTyp=″M″ SesSub=″X″>
<Pty ID=″CME″ R=″22″/>
<Pty ID=″909″ R=″17″/>
<Pty ID=″CME″ R=″21″/>
<Pty ID=″999″ R=″1″/>
<Pty ID=″IRS_XMGRN″ R=″24″>
<Sub ID=″1″ Typ=″26″/>
</Pty>
</RptSide>
</TrdCaptRpt>
</FIXML>

The Exchange (e.g. CME Clearing) may acknowledge the update by sending the trade capture report acknowledgement message to the Clearing Member firm.

An example exchange acknowledgement of the optimization tool Add Transfer Message may be sent from the Exchange (e.g. CME) back to Clearing Member firm, with TransTyp=“0”:

<FIXML>
<TrdCaptRptAck RptID=″135BCD40D95AP0001C1B6132021144″
TransTyp=″0″ RptTyp=″0″ TrdTyp=″3″ TrnsfrRsn=″C″
MtchID=″135BCD40D95AP0001C1B4″
ExecID=″00000000000000000045″ PxTyp=″2″ TrdDt=″2012-02-24″
BizDt=″2012-02-24″ MLegRptTyp=″1″ MtchStat=″1″
MsgEvtSrc=″CMESys″ RptRefID=″0012217″ TrdRptStat=″0″
TrdID=″10099″ TrdID2=″135BCD40D95AP0001C1B6″
TrdHandlInst=″2″ OrigTrdDt=″2012-02-24″ LastQty=″75″
LastPx=″98.82000000″ TxnTm=″2012-02-27T13:2021-06:00″>
<Hdr Snt=″2012-02-27T13:20:21-06:00″ SID=″CME″ TID=″999″
SSub=″CME″ TSub=″CME″/>
<Instrmt Sym=″GEZ4″ ID=″ED″ CFI=″FFDCSO″ SecTyp=″FUT″
Src=″H″ MMY=″20141200″ MatDt=″ 2014-12-15″ Mult=″2500″
Exch=″CME″ PxQteCcy=″USD″/>
<RptSide Side=″1″ ClOrdID=″0059″ InptSrc=″MQM″ InptDev=″API″
CustCpcty=″2″ OrdTyp=″M″ SesID=″RTH″ SesSub=″X″>
<Pty ID=″CME″ R=″21″/>
<Pty ID=″CME″ R=″22″/>
<Pty ID=″999″ R=″1″/>
<Pty ID=″IRS_XMGRN″ R=″24″>
<Sub ID=″1″ Typ=″26″/>
</Pty>
<Pty ID=″909″ R=″17″/>
<Pty ID=″999″ R=″4″/>
<Pty ID=″IRS_XMGRN″ R=″38″>
<Sub ID=″1″ Typ=″26″/>
</Pty>
</RptSide>
</TrdCaptRptAck>
</FIXML>

In some embodiments, a process that can be described as “portfolio margining of interest rate swaps and interest rate futures for house accounts” or “customer portfolio margining” is provided. Such processes may allow a Clearing House and clearing members, such as CME Clearing and the clearing members thereof, to recognize reduced risks associated with offsetting open positions, along with potential benefits that may include but are not limited to: reduced margin requirements for portfolios containing both products; reduced regulatory capital costs for FCMs; and/or reduced guaranty fund requirements for FCMs.

In some embodiments, the optimization tool algorithm is designed with a few specific objectives in mind: to reduce the combined margin of the LA and PMA; to be sufficiently fast to process a large number of accounts in a typical end-of-day time window; to minimize the margin across any combination of available positions; and to be deployable, such as to customer systems or premises, and not be overly dependent on internal systems of the Exchange.

As noted above, minimizing margin directly may be an unfeasible task for a few reasons. First, the historical value at risk (HVaR) and SPAN margin algorithms are complex and cannot be approximated easily. Because of this, minimizing margin directly may require direct margin calculations. Considering the number of possible allocations of positions in each portfolio, the number of margin calculations becomes very large and thus may be very time-consuming.

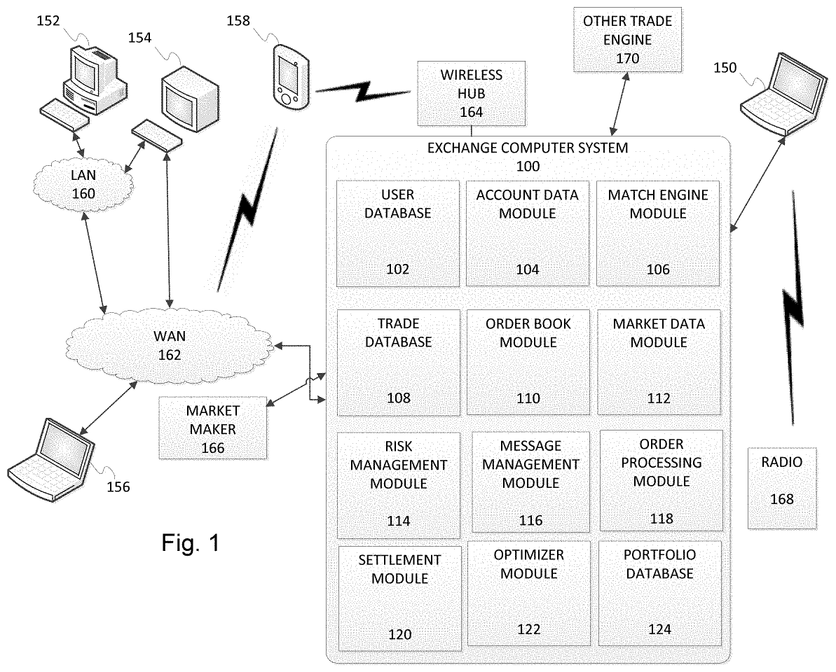

In some embodiments, systems and methods are disclosed for reducing, minimizing or otherwise optimizing a margin requirement across accounts such as OTC IRS (PMA) and IR futures accounts (LA). Some embodiments are desirably implemented with computer devices and computer networks, such as those shown in FIG. 1 and described below, which allow users (e.g., market participants) to access exchange trading information. It will be appreciated that the plurality of entities utilizing embodiments in accordance with the present teachings (e.g., the market participants) may be referred to by other nomenclature reflecting the role that the particular entity is performing with respect to a particular embodiment, and that a given entity may perform more than one role depending upon the implementation and the nature of the particular transaction being undertaken, as well as the entity's contractual and/or legal relationship with other market participants and/or the Exchange. An exemplary trading network environment for implementing trading systems and methods is shown in FIG. 1. An exchange computer system 100 receives orders and transmits market data related to orders and trades to users, such as via computer devices 114, 116, 118, 120, and 122, as further described below, coupled with the exchange computer system 100. In some embodiments, the exchange 100 includes a place or system that receives and/or executes orders for traded products.

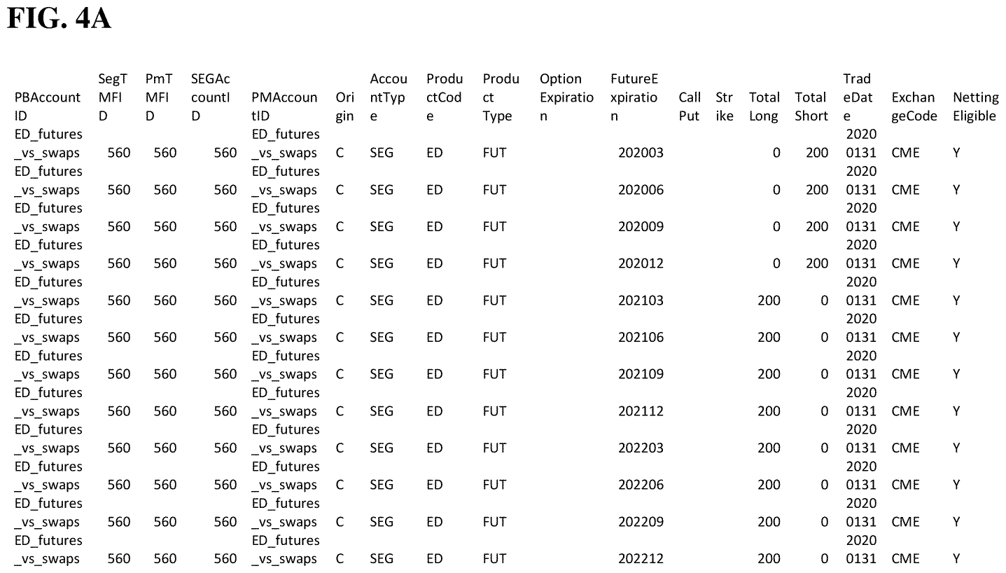

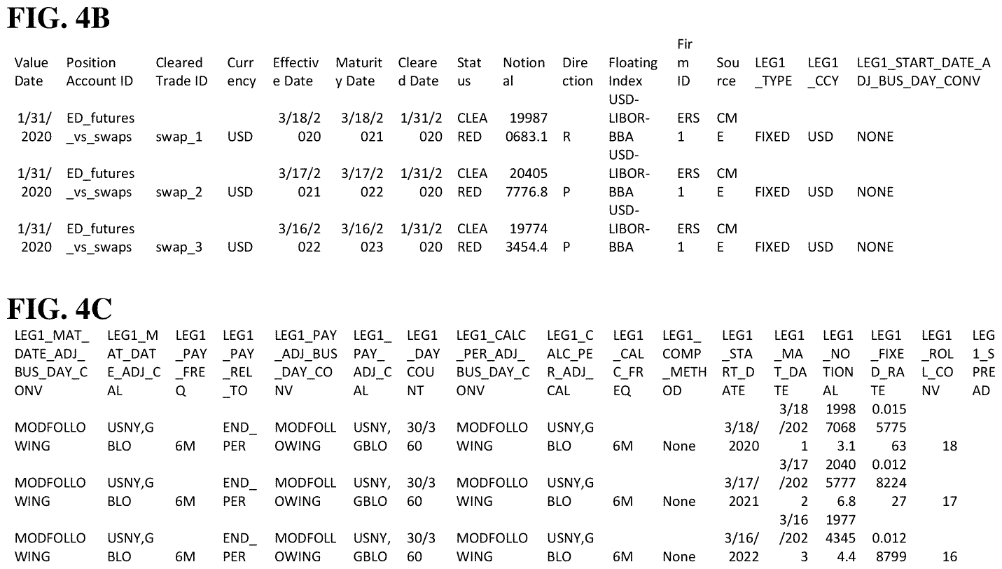

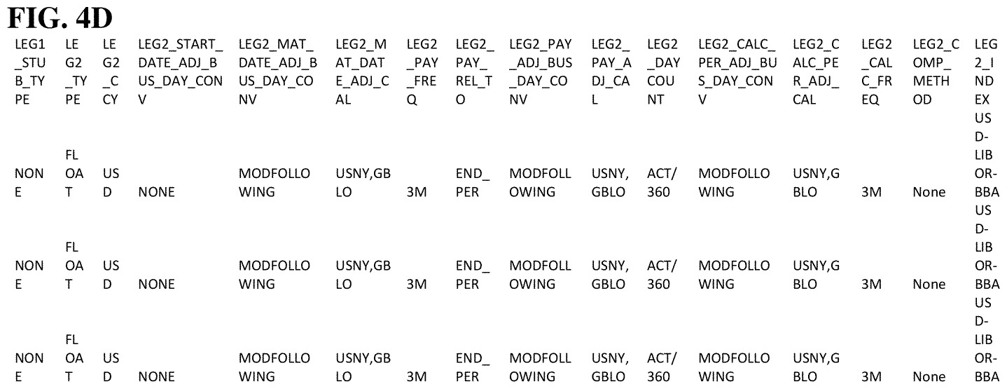

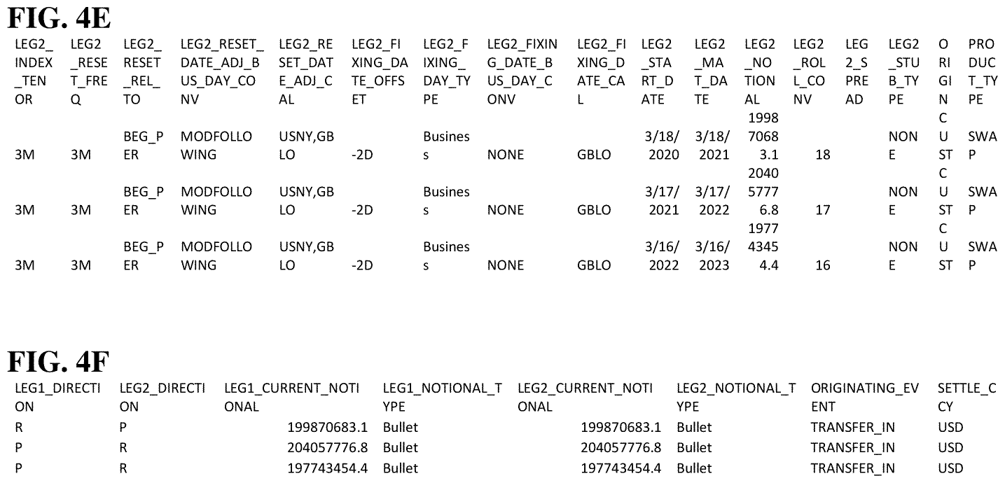

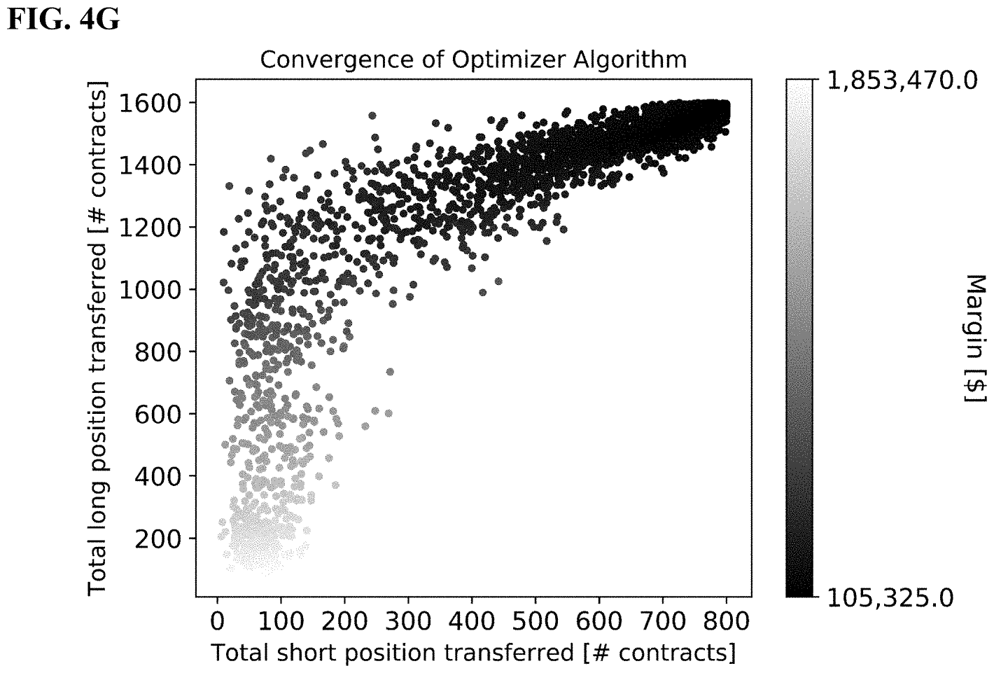

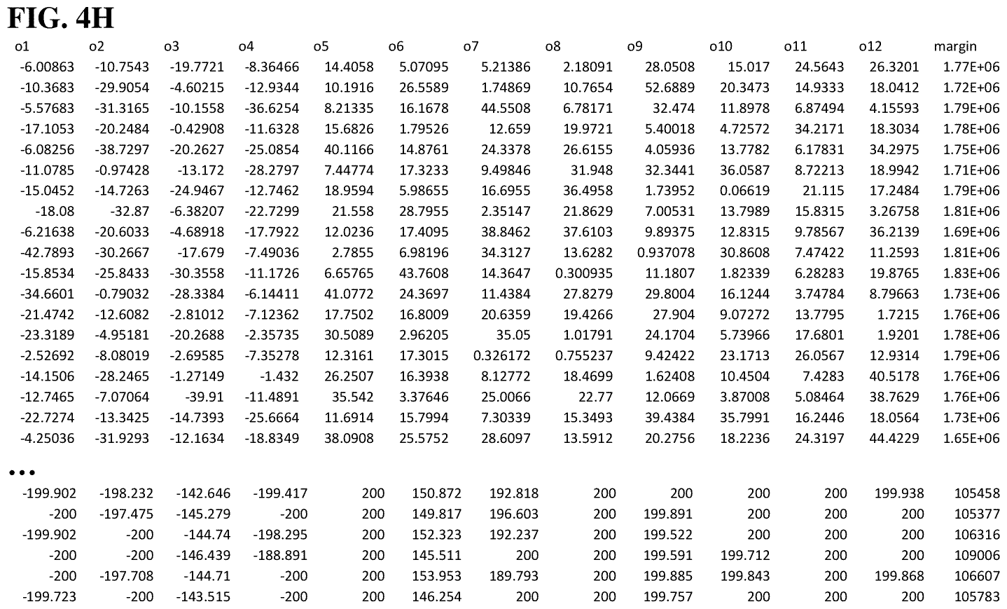

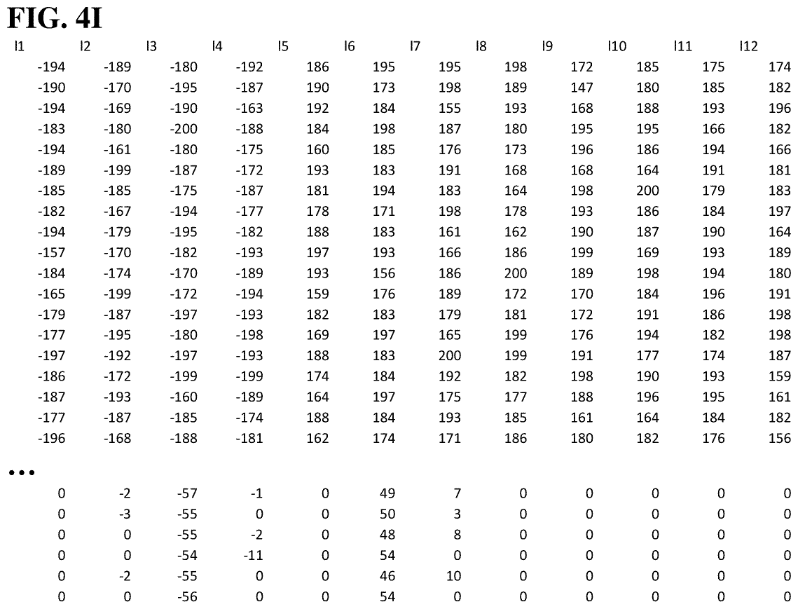

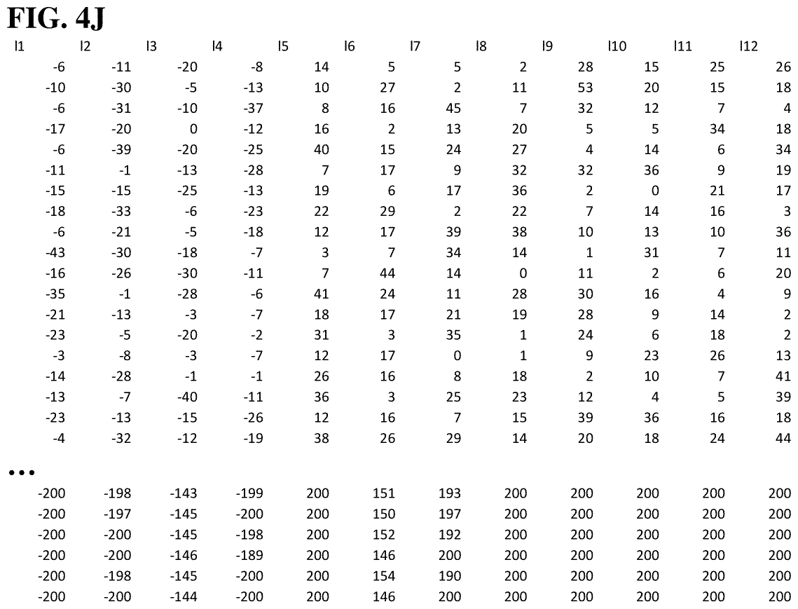

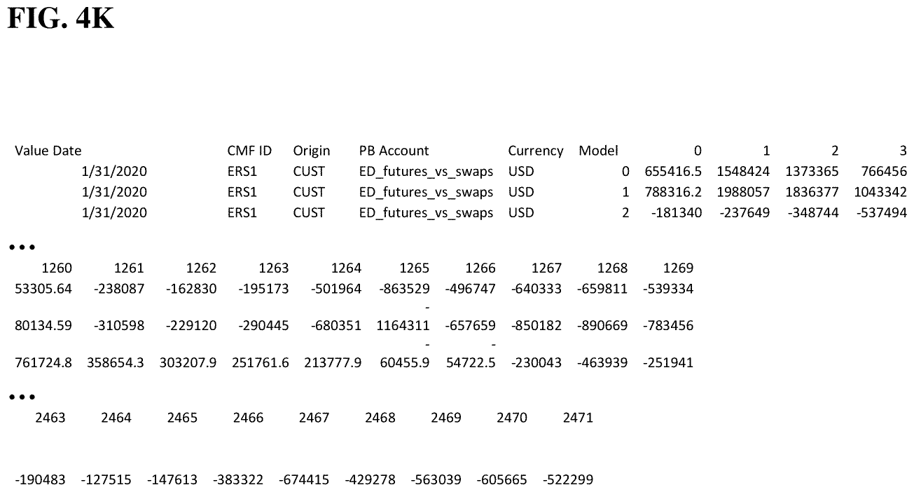

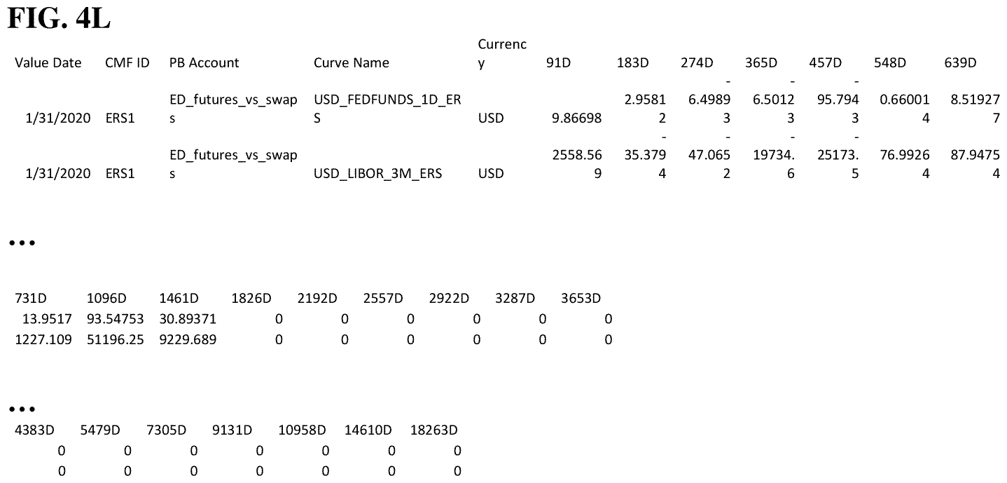

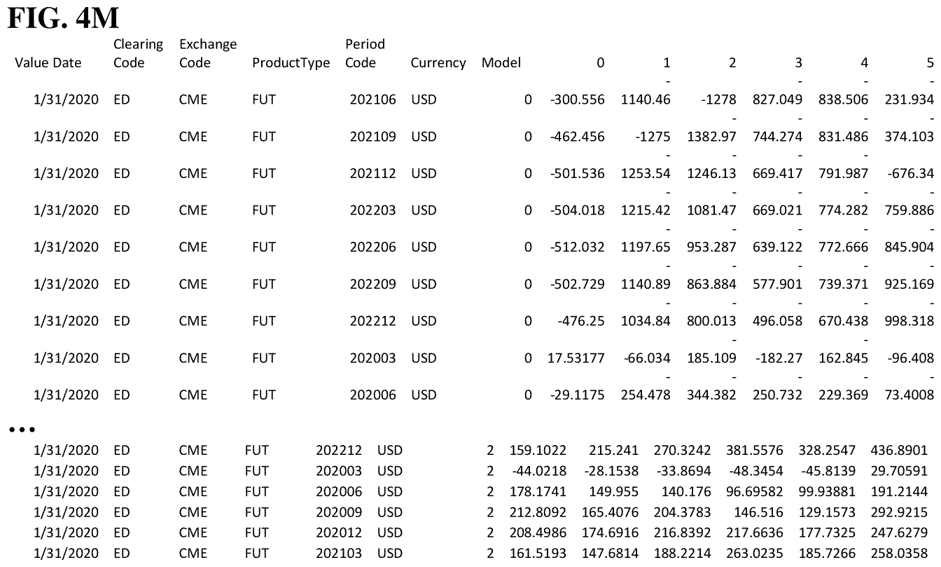

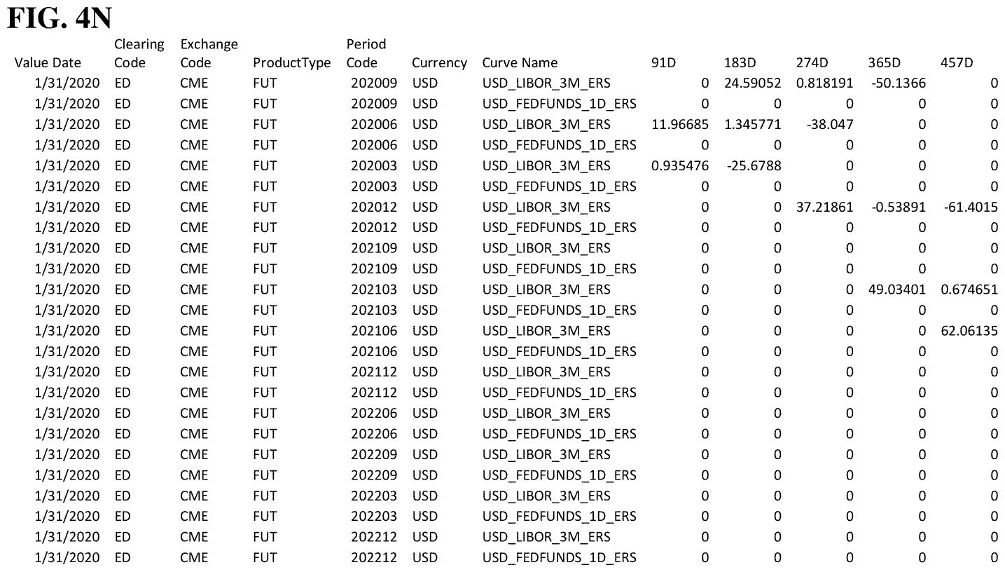

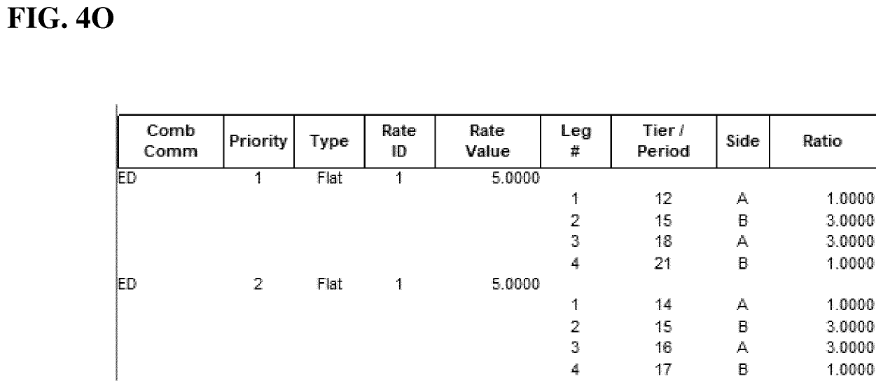

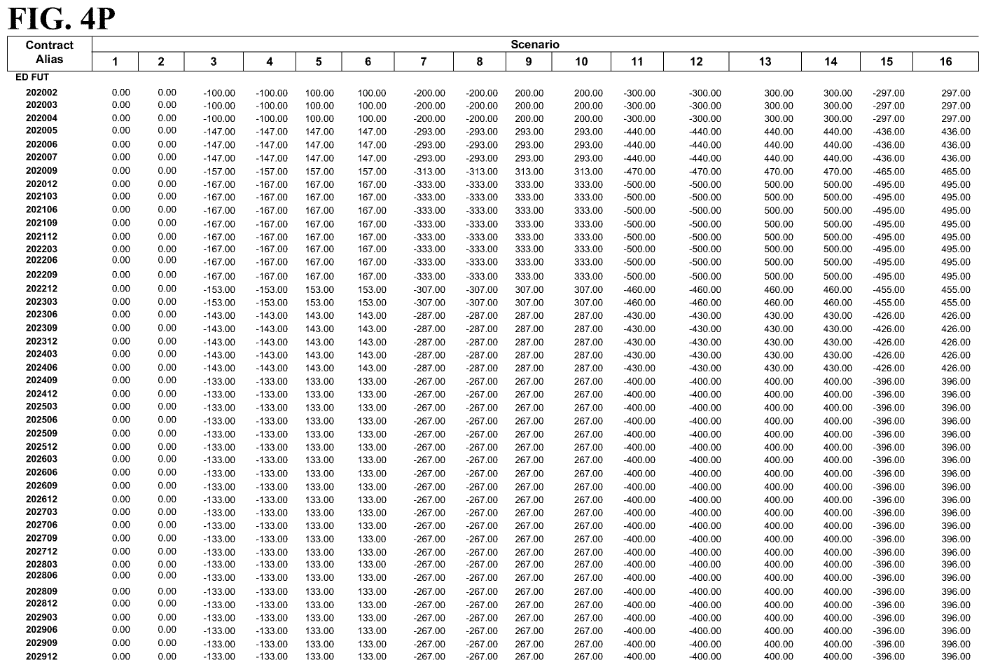

The following is an example of the operation of the disclosed embodiments. A sample LA comprising listed positions (futures, options on futures) present in the portfolio (SEG or PM account), each line is a position in a different contract is shown in the table of FIG. 4A. This example contains 12 positions in 12 different contracts. The fields shown in the figure include:

| | |
|---|---|
| AccountType | PM if position is in the PM account |
| | before optimization, otherwise |
| | SEG/NSEG |
| ProductCode | Describes the product: ED for |
| | Eurodollar futures/options, 21 for |
| | Treasury futures, etc. |
| Product Type | FUT for future, OOF for option on |
| | Future |
| Option Expiration | Option Expiry. Blank if Future |
| Future Expiration | Future Expiry or Underlying future |
| | expiry if OOF |
| CallPut | if OOF, describes if option is a call |
| | (=C) or a put (=P). Blank if FUT |
| Strike | Strike of the option. Blank if FUT |
| TotalLong | Total Long position in the contract |
| TotalShort | Total Short position in the contract |

FIGS. 4B-4F show a table containing OTC positions contained in the PM account. This example contains 3 swaps (one swap per line), and some of the main columns are:

| | |
|---|---|
| Value Date | Date at which OTC trade (e.g. interest |
| | rate swap) is being priced |
| Currency | currency of the OTC trade |
| Effective Date | start date of the swap |
| Maturity Date | end date |
| Notional | Notional of the swap |
| Direction | R for Receiver swap, P for payer swap |
| Floating Index | underlying index used to determine |
| | swap floating leg cash flows |
| LEG1_FIXED_RATE | fixed rate used to determine fixed leg |
| | cash flows |

The results of the initialization steps of both the Rapid SPAN and Fast HVAR are shown on FIGS. 4K-4P. FIGS. 4K and 4L show representative precalculated PNL's for the sample OTC positions. FIGS. 4M and 4N shows precalculated PNL and DL files for the portfolio margin eligible positions. FIGS. 4O and 4P shows the risk arrays and DL's for the Listed positions. In FIG. 4P, the ED contracts present in the LA are indicated by a dot. While the data shown in FIGS. 4K-4P is representative, one of ordinary skill in the art would be able to calculate the full data set as described herein.

The outputs of the disclosed embodiments based on the sample portfolios is shown in the following tables:

| | Margin Before/After and Offsets | |
|---|---|---|
| ValueType | Before | After |
| String | Double | Double |
| Sum | 1931312.819 | 105416.142 |
| TotalVaRWithNOV | 1392312.819 | 100151.142 |
| NOV | 0 | 0 |
| VAR | 1392312.819 | 100151.142 |
| SkewCharge | 0 | 0 |
| LiquidityUSD | 0 | 0 |
| SpanMargin | 539000 | 5265 |
| RealSpanMargin | 539000 | 5265 |
| RealMaintenanceMargin | 539000 | 5265 |

OFFSETS AND INITIAL/FINAL POSITIONS:

| exch | | | | | | | | initial | | |
|---|---|---|---|---|---|---|---|---|---|---|
| Code | pfCode | periodCode | undPeriodCode | optionType | strike | initialPM | finalPM | Listed | finalListed | offset |
| String | String | Int | Int | Int | Double | Double | Double | Double | Double | Double |
| CME | ED | 202003 | 202003 | 0 | 0 | 0 | −200 | −200 | 0 | −200 |
| CME | ED | 202006 | 202006 | 0 | 0 | 0 | −199 | −200 | −1 | −199 |
| CME | ED | 202009 | 202009 | 0 | 0 | 0 | −143 | −200 | −57 | −143 |
| CME | ED | 202012 | 202012 | 0 | 0 | 0 | −199 | −200 | −1 | −199 |
| CME | ED | 202103 | 202103 | 0 | 0 | 0 | 200 | 200 | 0 | 200 |
| CME | ED | 202106 | 202106 | 0 | 0 | 0 | 154 | 200 | 46 | 154 |
| CME | ED | 202109 | 202109 | 0 | 0 | 0 | 191 | 200 | 9 | 191 |
| CME | ED | 202112 | 202112 | 0 | 0 | 0 | 200 | 200 | 0 | 200 |
| CME | ED | 202203 | 202203 | 0 | 0 | 0 | 200 | 200 | 0 | 200 |
| CME | ED | 202206 | 202206 | 0 | 0 | 0 | 200 | 200 | 0 | 200 |
| CME | ED | 202209 | 202209 | 0 | 0 | 0 | 200 | 200 | 0 | 200 |
| CME | ED | 202212 | 202212 | 0 | 0 | 0 | 200 | 200 | 0 | 200 |

FIG. 4G depicts a chart illustrating convergence based on the iterative evaluations performed by the optimizer according to the disclosed embodiments as shown in the table depicted in FIG. 4C. Since the sample portfolio is well hedged between Listed and PM side, we expect close to maximum transfer (=transferring 800 short and 1600 long). In the chart, x-axis is total transfer of short positions, and y-axis is total transfer of long positions (to reduce from 12 to 2 dimensions and generate chart). Optimizer as expected transfers 95% of all positions.

The table of FIG. 4H Contains a representative sample of all transfers attempted by the optimizer, and the total margin (Span+VaR) corresponding to these transfers. In this example there are 12 listed positions, and the optimizer tries to find the optimal number of contracts to move from SEG to PM, to minimize total margin. It is impossible to actually try each possible combinations of transfers, so the optimizer tries many different possible combinations using a differential evolution algorithm, to get closer to the optimal number of transfers at each iteration. It repeats the process 500 times, and for each of these 500 iterations the algorithm tries 20 ‘candidates’ in the possible transfers space, then evolves the candidates to create the next generation using the evolutionary strategy. The columns o1, . . . , o12 show how many contracts of type 1, . . . , 12 (same ordering as in the table of FIG. 4A) it tries to transfer at this step. The column ‘margin’ gives the total (Span+PM) margin corresponding to Span margin of (listed position minus transfers)+VaR of (original OTC trades+transferred positions).

FIGS. 4I and 4J show the corresponding changes to the LA and PMA for each iteration shown in the table of FIG. 4H. FIG. 4I shows the iterative changes to the LA where the initial values were as shown in the table above. FIG. 4J shows the iterative changes to the PMA where the initial values were as shown in the table above.

### Exchange Computer System

An exchange provides one or more markets for the purchase and sale of various types of products including financial instruments such as stocks, bonds, futures contracts, options, currency, cash, swaps and other similar instruments. Agricultural products and commodities are also examples of products traded on such exchanges. As was described above, a futures contract is a product that is a contract for the future delivery of a financial instrument such as a quantity of grains, metals, oils, bonds, currency, or cash settled against a rate. Generally, each exchange establishes a specification for each market provided thereby that defines at least the product traded in the market, minimum quantities that must be traded, and minimum changes in price (e.g., tick size). For some types of products (e.g., futures or options), the specification further defines a quantity of the underlying product represented by one unit (or lot) of the product, and delivery and expiration dates. For some types of products (e.g., variable commodities), the specification may further define variables, step sizes, premiums, or discounts for use in processing orders. The exchange may further define the matching algorithm, or rules, by which incoming orders will be matched/allocated to resting orders.

Generally, a market may involve market makers, such as market participants who consistently provide bids and/or offers at specific prices in a manner typically conducive to balancing risk, and market takers who may be willing to execute transactions at prevailing bids or offers or may be characterized by more aggressive actions so as to maintain risk and/or exposure as a speculative investment strategy. From an alternate perspective, a market maker may be considered a market participant who places an order to sell at a price at which there is no previously or concurrently provided counter order. A market taker may be considered a market participant who places an order to buy at a price at which there is a previously or concurrently provided counter order. A balanced and efficient market may involve both market makers and market takers, coexisting in a mutually beneficial basis. The mutual existence, when functioning properly, may facilitate liquidity in the market such that a market may exist with “tight” bid-ask spreads (e.g., small difference between bid and ask prices) and may also feature high volumes of executed transactions indicating that large quantity orders may be executed without driving prices significantly higher or lower.

As was described above, a financial instrument trading system, such as a futures exchange, such as the Chicago Mercantile Exchange Inc. (CME), provides a contract market where financial instruments, e.g., futures and options on futures, are traded using electronic systems and may operate under a central counterparty model, where the exchange acts as an intermediary between market participants for the transaction of financial instruments.

Electronic messages such as incoming messages from market participants, i.e., “outright” messages, e.g., trade order messages, etc., are sent from client devices associated with market participants, or their representatives, to an electronic trading or market system.

### Electronic Trading

Electronic trading of financial instruments, such as futures contracts, is conducted by market participants sending orders, such as to buy or sell one or more futures contracts, in electronic form to the exchange. These electronically submitted orders to buy and sell are then matched, if possible, by the exchange, i.e., by the exchange's matching engine, to execute a trade. Outstanding (unmatched, wholly unsatisfied/unfilled or partially satisfied/filled) orders are maintained in one or more data structures or databases referred to as “order books,” such orders being referred to as “resting,” and made visible, i.e., their availability for trading is advertised, to the market participants through electronic notifications/broadcasts, referred to as market data feeds. An order book is typically maintained for each product, e.g., instrument, traded on the electronic trading system and generally defines or otherwise represents the state of the market for that product, i.e., the current prices at which the market participants are willing to buy or sell various quantities of that product. As such, as used herein, an order book for a product may also be referred to as a market for that product.

Upon receipt of an incoming order to trade in a particular financial instrument, whether for a single-component financial instrument, e.g., a single futures contract, or for a multiple-component financial instrument, e.g., a combination contract such as a spread contract, a match engine, as described herein, will attempt to identify a previously received but unsatisfied order counter thereto, i.e., for the opposite transaction (buy or sell) in the same financial instrument at the same or better price (but not necessarily for the same quantity unless, for example, either order specifies a condition that it must be entirely filled or not at all).

Previously received but unsatisfied orders, i.e., orders which either did not match with a counter order when they were received or their quantity was only partially satisfied, referred to as a partial fill, are maintained by the electronic trading system in an order book database/data structure to await the subsequent arrival of matching orders or the occurrence of other conditions which may cause the order to be modified or otherwise removed from the order book.

If the match engine identifies one or more suitable previously received but unsatisfied counter orders, they, and the incoming order, are matched to execute a trade therebetween to at least partially satisfy the quantities of one or both of the incoming order or the identified orders. If there remains any residual unsatisfied quantity of the identified one or more orders, those orders are left on the order book with their remaining quantity to await a subsequent suitable counter order, i.e., to rest. If the match engine does not identify a suitable previously received but unsatisfied counter order, or the one or more identified suitable previously received but unsatisfied counter orders are for a lesser quantity than the incoming order, the incoming order is placed on the order book, referred to as “resting”, with original or remaining unsatisfied quantity, to await a subsequently received suitable order counter thereto. The match engine then generates match event data reflecting the result of this matching process. Other components of the electronic trading system, as will be described, then generate the respective order acknowledgment and market data messages and transmit those messages to the market participants.

Matching, which is a function typically performed by the exchange, is a process, for a given order which specifies a desire to buy or sell a quantity of a particular instrument at a particular price, of seeking/identifying one or more wholly or partially, with respect to quantity, satisfying counter orders thereto, e.g., a sell counter to an order to buy, or vice versa, for the same instrument at the same, or sometimes better, price (but not necessarily the same quantity), which are then paired for execution to complete a trade between the respective market participants (via the exchange) and at least partially satisfy the desired quantity of one or both of the order and/or the counter order, with any residual unsatisfied quantity left to await another suitable counter order, referred to as “resting.” A match event may occur, for example, when an aggressing order matches with a resting order. In one embodiment, two orders match because one order includes instructions for or specifies buying a quantity of an instrument at a price, and the other order includes instructions for or specifies selling a (different or same) quantity of the instrument at a same or better price. It should be appreciated that performing an instruction associated with a message may include attempting to perform the instruction. Whether or not an exchange computer system is able to successfully perform an instruction may depend on the state of the electronic marketplace.

While the disclosed embodiments will be described with respect to a product by product or market by market implementation, e.g., implemented for each market/order book, it will be appreciated that the disclosed embodiments may be implemented so as to apply across markets for multiple products traded on one or more electronic trading systems, such as by monitoring an aggregate, correlated or other derivation of the relevant indicative parameters as described herein.

While the disclosed embodiments may be discussed in relation to futures and/or options on futures trading, it should be appreciated that the disclosed embodiments may be applicable to any equity, fixed income security, currency, commodity, swap, options or futures trading system or market now available or later developed. It may be appreciated that a trading environment, such as a futures exchange as described herein, implements one or more economic markets where rights and obligations may be traded. As such, a trading environment may be characterized by a need to maintain market integrity, transparency, predictability, fair/equitable access, and participant expectations with respect thereto. In addition, it may be appreciated that electronic trading systems further impose additional expectations and demands by market participants as to transaction processing speed, latency, capacity, and response time, while creating additional complexities relating thereto. Accordingly, as will be described, the disclosed embodiments may further include functionality to ensure that the expectations of market participants are met, e.g., that transactional integrity and predictable system responses are maintained.

Financial instrument trading systems allow traders to submit orders and receive confirmations, market data, and other information electronically via electronic messages exchanged using a network. Electronic trading systems offer an efficient, fair and balanced market where market prices reflect a true consensus of the value of products traded among the market participants. Electronic marketplaces use electronic messages to communicate actions and related data of the electronic marketplace between market participants, clearing firms, clearing houses, and other parties. The messages can be received using an electronic trading system, wherein an action or transaction associated with the messages may be executed. For example, the message may contain information relating to an order to buy or sell a product in a particular electronic marketplace, and the action associated with the message may indicate that the order is to be placed in the electronic marketplace such that other orders which were previously placed may potentially be matched to the order of the received message. Thus, the electronic marketplace may conduct market activities through electronic systems.

As may be perceived/experienced by the market participants from outside the exchange or electronic trading system operated thereby, the following sequence describes how, at least in part, information may be propagated in such a system and how orders may be processed: (1) An opportunity is created at a matching engine of the exchange, such as by placing a recently received but unmatched order on the order book to rest; (2) The matching engine creates an update reflecting the opportunity and sends it to a feed engine; (3) The feed engine multicasts it to all of the market participants to advertise the opportunity to trade; (4) The market participants evaluate the opportunity and each, upon completion of their evaluation, may or may not choose to respond with an order responsive to the resting order, i.e., counter to the resting order; (5) The exchange gateway receives any counter orders generated by the market participants, sends confirmation of receipt back directly to each submitting market participant, and forwards the received orders to the matching engine; and (6) The matching engine evaluates the received orders and matches the first arriving order against the resting opportunity and a trade is executed.

### Matching and Transaction Processing

Market participants, e.g., traders, use software to send orders or messages to the trading platform. The order identifies the product, the quantity of the product the trader wishes to trade, a price at which the trader wishes to trade the product, and a direction of the order (i.e., whether the order is a bid, i.e., an offer to buy, or an ask, i.e., an offer to sell). It will be appreciated that there may be other order types or messages that traders can send including requests to modify or cancel a previously submitted order.

As was described above, the exchange computer system monitors incoming orders received thereby and attempts to identify, i.e., match or allocate, as described herein, one or more previously received, but not yet matched, orders, i.e., limit orders to buy or sell a given quantity at a given price, referred to as “resting” orders, stored in an order book database, wherein each identified order is contra to the incoming order and has a favorable price relative to the incoming order. An incoming order may be an “aggressor” order, i.e., a market order to sell a given quantity at whatever may be the current resting bid order price(s) or a market order to buy a given quantity at whatever may be the current resting ask order price(s). An incoming order may be a “market making” order, i.e., a market order to buy or sell at a price for which there are currently no resting orders. In particular, if the incoming order is a bid, i.e., an offer to buy, then the identified order(s) will be an ask, i.e., an offer to sell, at a price that is identical to or higher than the bid price. Similarly, if the incoming order is an ask, i.e., an offer to sell, the identified order(s) will be a bid, i.e., an offer to buy, at a price that is identical to or lower than the offer price.

An exchange computer system may receive conditional orders or messages for a data object, where the order may include two prices or values: a reference value and a stop value. A conditional order may be configured so that when a product represented by the data object trades at the reference price, the stop order is activated at the stop value. For example, if the exchange computer system's order management module (described below) includes a stop order with a stop price of 5 and a limit price of 1 for a product, and a trade at 5 (i.e., the stop price of the stop order) occurs, then the exchange computer system attempts to trade at 1 (i.e., the limit price of the stop order). In other words, a stop order is a conditional order to trade (or execute) at the limit price that is triggered (or elected) when a trade at the stop price occurs.

Stop orders also rest on, or are maintained in, an order book to monitor for a trade at the stop price, which triggers an attempted trade at the limit price. In some embodiments, a triggered limit price for a stop order may be treated as an incoming order.

Upon identification (matching) of a contra order(s), a minimum of the quantities associated with the identified order and the incoming order is matched and that quantity of each of the identified and incoming orders become two halves of a matched trade that is sent to a clearing house. The exchange computer system considers each identified order in this manner until either all the identified orders have been considered or all the quantity associated with the incoming order has been matched, i.e., the order has been filled. If any quantity of the incoming order remains, an entry may be created in the order book database and information regarding the incoming order is recorded therein, i.e., a resting order is placed on the order book for the remaining quantity to await a subsequent incoming order counter thereto.

It should be appreciated that in electronic trading systems implemented via an exchange computer system, a trade price (or match value) may differ from (i.e., be better for the submitter, e.g., lower than a submitted buy price or higher than a submitted sell price) the limit price that is submitted, e.g., a price included in an incoming message, or a triggered limit price from a stop order.

As used herein, “better” than a reference value means lower than the reference value if the transaction is a purchase (or acquire) transaction, and higher than the reference value if the transaction is a sell transaction. Said another way, for purchase (or acquire) transactions, lower values are better, and for sell (or relinquish) transactions, higher values are better.

Traders access the markets on a trading platform using trading software that receives and displays at least a portion of the order book for a market, i.e., at least a portion of the currently resting orders, enables a trader to provide parameters for an order for the product traded in the market, and transmits the order to the exchange computer system. The trading software typically includes a graphical user interface to display at least a price and quantity of some of the entries in the order book associated with the market. The number of entries of the order book displayed is generally preconfigured by the trading software, limited by the exchange computer system, or customized by the user. Some graphical user interfaces display order books of multiple markets of one or more trading platforms. The trader may be an individual who trades on his/her behalf, a broker trading on behalf of another person or entity, a group, or an entity. Furthermore, the trader may be a system that automatically generates and submits orders.

If the exchange computer system identifies that an incoming market order may be filled by a combination of multiple resting orders, e.g., the resting order at the best price only partially fills the incoming order, the exchange computer system may allocate the remaining quantity of the incoming order, i.e., that which was not filled by the resting order at the best price, among such identified orders in accordance with prioritization and allocation rules/algorithms, referred to as “allocation algorithms” or “matching algorithms,” as, for example, may be defined in the specification of the particular financial product or defined by the exchange for multiple financial products. Similarly, if the exchange computer system identifies multiple orders contra to the incoming limit order and that have an identical price which is favorable to the price of the incoming order, i.e., the price is equal to or better, e.g., lower if the incoming order is a buy (or instruction to purchase, or instruction to acquire) or higher if the incoming order is a sell (or instruction to relinquish), than the price of the incoming order, the exchange computer system may allocate the quantity of the incoming order among such identified orders in accordance with the matching algorithms as, for example, may be defined in the specification of the particular financial product or defined by the exchange for multiple financial products.

An exchange responds to inputs, such as trader orders, cancellation, etc., in a manner as expected by the market participants, such as based on market data, e.g., prices, available counter-orders, etc., to provide an expected level of certainty that transactions will occur in a consistent and predictable manner and without unknown or unascertainable risks. Accordingly, the method by which incoming orders are matched with resting orders must be defined so that market participants have an expectation of what the result will be when they place an order or have resting orders and an incoming order is received, even if the expected result is, in fact, at least partially unpredictable due to some component of the process being random or arbitrary or due to market participants having imperfect or less than all information, e.g., unknown position of an order in an order book. Typically, the exchange defines the matching/allocation algorithm that will be used for a particular financial product, with or without input from the market participants. Once defined for a particular product, the matching/allocation algorithm is typically not altered, except in limited circumstance, such as to correct errors or improve operation, so as not to disrupt trader expectations. It will be appreciated that different products offered by a particular exchange may use different matching algorithms.

For example, a first-in/first-out (FIFO) matching algorithm, also referred to as a “Price Time” algorithm, considers each identified order sequentially in accordance with when the identified order was received. The quantity of the incoming order is matched to the quantity of the identified order at the best price received earliest, then quantities of the next earliest best price orders, and so on until the quantity of the incoming order is exhausted. Some product specifications define the use of a pro-rata matching algorithm, wherein a quantity of an incoming order is allocated to each of plurality of identified orders proportionally. Some exchange computer systems provide a priority to certain standing orders in particular markets. An example of such an order is the first order that improves a price (i.e., improves the market) for the product during a trading session. To be given priority, the trading platform may require that the quantity associated with the order is at least a minimum quantity. Further, some exchange computer systems cap the quantity of an incoming order that is allocated to a standing order on the basis of a priority for certain markets. In addition, some exchange computer systems may give a preference to orders submitted by a trader who is designated as a market maker for the product. Other exchange computer systems may use other criteria to determine whether orders submitted by a particular trader are given a preference. Typically, when the exchange computer system allocates a quantity of an incoming order to a plurality of identified orders at the same price, the trading host allocates a quantity of the incoming order to any orders that have been given priority. The exchange computer system thereafter allocates any remaining quantity of the incoming order to orders submitted by traders designated to have a preference, and then allocates any still remaining quantity of the incoming order using the FIFO or pro-rata algorithms. Pro-rata algorithms used in some markets may require that an allocation provided to a particular order in accordance with the pro-rata algorithm must meet at least a minimum allocation quantity. Any orders that do not meet or exceed the minimum allocation quantity are allocated to on a FIFO basis after the pro-rata allocation (if any quantity of the incoming order remains). More information regarding order allocation may be found in U.S. Pat. No. 7,853,499, the entirety of which is incorporated by reference herein and relied upon.

Other examples of matching algorithms which may be defined for allocation of orders of a particular financial product include: Price Explicit Time; Order Level Pro Rata; Order Level Priority Pro Rata; Preference Price Explicit Time; Preference Order Level Pro Rata; Preference Order Level Priority Pro Rata; Threshold Pro-Rata; Priority Threshold Pro-Rata; Preference Threshold Pro-Rata; Priority Preference Threshold Pro-Rata; and Split Price-Time Pro-Rata, which are described in U.S. patent application Ser. No. 13/534,499, filed on Jun. 27, 2012, entitled “Multiple Trade Matching Algorithms,” published as U.S. Patent Application Publication No. 2014/0006243 A1, the entirety of which is incorporated by reference herein and relied upon.

With respect to resting orders, allocation/matching suitable resting orders to match against an incoming order can be performed, as described herein, in many different ways. Generally, it will be appreciated that allocation/matching algorithms are only needed when the incoming order quantity is less than the total quantity of the suitable resting orders as, only in this situation, is it necessary to decide which resting order(s) will not be fully satisfied, which trader(s) will not get their orders filled. It can be seen from the above descriptions of the matching/allocation algorithms, that they fall generally into three categories: time priority/first-in-first-out (“FIFO”), pro rata, or a hybrid of FIFO and pro rata.

FIFO generally rewards the first trader to place an order at a particular price and maintains this reward indefinitely. So, if a trader is the first to place an order at price X, no matter how long that order rests and no matter how many orders may follow at the same price, as soon as a suitable incoming order is received, that first trader will be matched first. This “first mover” system may commit other traders to positions in the queue after the first move traders. Furthermore, while it may be beneficial to give priority to a trader who is first to place an order at a given price because that trader is, in effect, taking a risk, the longer that the trader's order rests, the less beneficial it may be. For instance, it could deter other traders from adding liquidity to the marketplace at that price because they know the first mover (and potentially others) already occupies the front of the queue.

With a pro rata allocation, incoming orders are effectively split among suitable resting orders. This provides a sense of fairness in that everyone may get some of their order filled. However, a trader who took a risk by being first to place an order (a “market turning” order) at a price may end up having to share an incoming order with a much later submitted order. Furthermore, as a pro rata allocation distributes the incoming order according to a proportion based on the resting order quantities, traders may place orders for large quantities, which they are willing to trade but may not necessarily want to trade, in order to increase the proportion of an incoming order that they will receive. This results in an escalation of quantities on the order book and exposes a trader to a risk that someone may trade against one of these orders and subject the trader to a larger trade than they intended. In the typical case, once an incoming order is allocated against these large resting orders, the traders subsequently cancel the remaining resting quantity which may frustrate other traders. Accordingly, as FIFO and pro rata both have benefits and problems, exchanges may try to use hybrid allocation/matching algorithms which attempt to balance these benefits and problems by combining FIFO and pro rata in some manner. However, hybrid systems define conditions or fixed rules to determine when FIFO should be used and when pro rata should be used. For example, a fixed percentage of an incoming order may be allocated using a FIFO mechanism with the remainder being allocated pro rata.

### Clearing House

The clearing house of an exchange clears, settles and guarantees matched transactions in contracts occurring through the facilities of the exchange. In addition, the clearing house establishes and monitors financial requirements for clearing members and conveys certain clearing privileges in conjunction with the relevant exchange markets. The clearing house also manages the delivery process.

The clearing house establishes clearing level performance bonds (margins) for all products of the exchange and establishes minimum performance bond requirements for customers of such products. A performance bond, also referred to as a margin requirement, corresponds with the funds that must be deposited by a customer with his or her broker, by a broker with a clearing member or by a clearing member with the clearing house, for the purpose of insuring the broker or clearing house against loss on open futures or options contracts. This is not a part payment on a purchase. The performance bond helps to ensure the financial integrity of brokers, clearing members and the exchange as a whole. The performance bond refers to the minimum dollar deposit required by the clearing house from clearing members in accordance with their positions. Maintenance, or maintenance margin, refers to a sum, usually smaller than the initial performance bond, which must remain on deposit in the customer's account for any position at all times. The initial margin is the total amount of margin per contract required by the broker when a futures position is opened. A drop in funds below this level requires a deposit back to the initial margin levels, i.e., a performance bond call. If a customer's equity in any futures position drops to or under the maintenance level because of adverse price action, the broker must issue a performance bond/margin call to restore the customer's equity. A performance bond call, also referred to as a margin call, is a demand for additional funds to bring the customer's account back up to the initial performance bond level whenever adverse price movements cause the account to go below the maintenance.

The exchange derives its financial stability in large part by removing debt obligations among market participants relatively quickly. This is accomplished by determining a settlement price at the close of the market each day for each contract and marking all open positions to that price, referred to as “mark to market.” Every contract is debited or credited based on that trading session's gains or losses. As prices move for or against a position, funds flow into and out of the trading account. In the case of the CME, each business day by 6:40 a.m. Chicago time, based on the mark-to-the-market of all open positions to the previous trading day's settlement price, the clearing house pays to or collects cash from each clearing member. This cash flow, known as settlement variation, is performed by CME's settlement banks based on instructions issued by the clearing house. All payments to and collections from clearing members are made in “same-day” funds. In addition to the 6:40 a.m. settlement, a daily intra-day mark-to-the market of all open positions, including trades executed during the overnight GLOBEX®, the CME's electronic trading systems, trading session and the current day's trades matched before 11:15 a.m., is performed using current prices. The resulting cash payments are made intra-day for same day value. In times of extreme price volatility, the clearing house has the authority to perform additional intra-day mark-to-the-market calculations on open positions and to call for immediate payment of settlement variation. CME's mark-to-the-market settlement system may differ from the settlement systems implemented by many other financial markets, including the interbank, Treasury securities, over-the-counter foreign exchange and debt, options, and equities markets, where participants regularly assume credit exposure to each other. In those markets, the failure of one participant can have a ripple effect on the solvency of the other participants. Conversely, CME's mark-to-the-market system may not allow losses to accumulate over time or allow a market participant the opportunity to defer losses associated with market positions.

While the disclosed embodiments may be described in reference to the CME, it should be appreciated that these embodiments are applicable to any exchange. Such other exchanges may include a clearing house that, like the CME clearing house, clears, settles, and guarantees all matched transactions in contracts of the exchange occurring through its facilities. In addition, such clearing houses establish and monitor financial requirements for clearing members and convey certain clearing privileges in conjunction with the relevant exchange markets.

The disclosed embodiments are also not limited to uses by a clearing house or exchange for purposes of enforcing a performance bond or margin requirement. For example, a market participant may use the disclosed embodiments in a simulation or other analysis of a portfolio. In such cases, the settlement price may be useful as an indication of a value at risk and/or cash flow obligation rather than a performance bond. The disclosed embodiments may also be used by market participants or other entities to forecast or predict the effects of a prospective position on the margin requirement of the market participant.

Clearing houses, like the CME clearing house, may specify the conditions of delivery for the contracts they cover. The exchange designates warehouse and delivery locations for many commodities. When delivery takes place, a warrant or bearer receipt that represents a certain quantity and quality of a commodity in a specific location changes hands from the seller to the buyer who then makes full payment. The buyer has the right to remove the commodity from the warehouse or has the option of leaving the commodity at the storage facility for a periodic fee. The buyer could also arrange with the warehouse to transport the commodity to another location of his or her choice, including his or her home, and pays any transportation fees. In addition to delivery specifications stipulated by the exchanges, the quality, grade, or nature of the underlying asset to be delivered are also regulated by the exchanges.

The delivery process may involve several deadlines that are handled by the exchange clearing house. Different commodities may include different parameters and timing for delivery. The first deadline of an example delivery process is called position day. This is the day that the short position holder in the market indicates to the exchange clearing house that the holder intends to make delivery on his futures position and registers a shipping certificate in the clearing delivery system. Also, starting on the first position day, each participant reports all of its open long positions to the clearing house. The clearing house ranks the long positions according to the amount of time they have been open and assigns the oldest long position to the short position holder that has given his intention to deliver.

At a second deadline, referred to as notice day, the short position holder and long position holder receive notification that they have been matched, and the long position holder receives an invoice from the clearing house. A third deadline is the actual delivery day. The long position holder makes payment to the clearing house, and the clearing house simultaneously transfers the payment from the long to the short position holder, and the shipping certificate is transferred from the short to the long position holder. Now the long position holder is the owner of the shipping certificate and the participant has several options. In an example of grain, the participant can hold the certificate indefinitely, but must pay the warehouse that issued the certificate storage charges, that are collected and distributed monthly by the clearing house. The participant can cancel the shipping certificate and order the issuing warehouse to load-out the physical commodity into a conveyance that he places at the issuing warehouse. The participant can transfer or sell the certificate to someone else. Or the participant can go back into the futures market and open a new position by selling futures, in which case he now becomes the short position holder. The participant may then initiate a new three-day delivery process, that would entail re-delivery of the warehouse certificate the participant now owns. During this time, the participant will continue to pay storage charges to the warehouse until he re-delivers the certificate.

### Computing Environment

The embodiments may be described in terms of a distributed computing system. The examples identify a specific set of components useful in a futures and options exchange. However, many of the components and inventive features are readily adapted to other electronic trading environments. The specific examples described herein may teach specific protocols and/or interfaces, although it should be understood that the principles involved may be extended to, or applied in, other protocols and interfaces.

It should be appreciated that the plurality of entities utilizing or involved with the disclosed embodiments, e.g., the market participants, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant and/or the exchange.

An exemplary trading network environment for implementing trading systems and methods is shown in FIG. 1. An exchange computer system 100 receives messages that include orders and transmits market data related to orders and trades to users, such as via wide area network 162 and/or local area network 160 and computer devices 150, 152, 154, 156 and 158, as described herein, coupled with the exchange computer system 100. Wherein the exchanges computer system 100 implements clearing functions, as described herein, it may also be referred to as a central counterparty computing system 100.

Herein, the phrase “coupled with” is defined to mean directly connected to or indirectly connected through one or more intermediate components. Such intermediate components may include both hardware- and software-based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

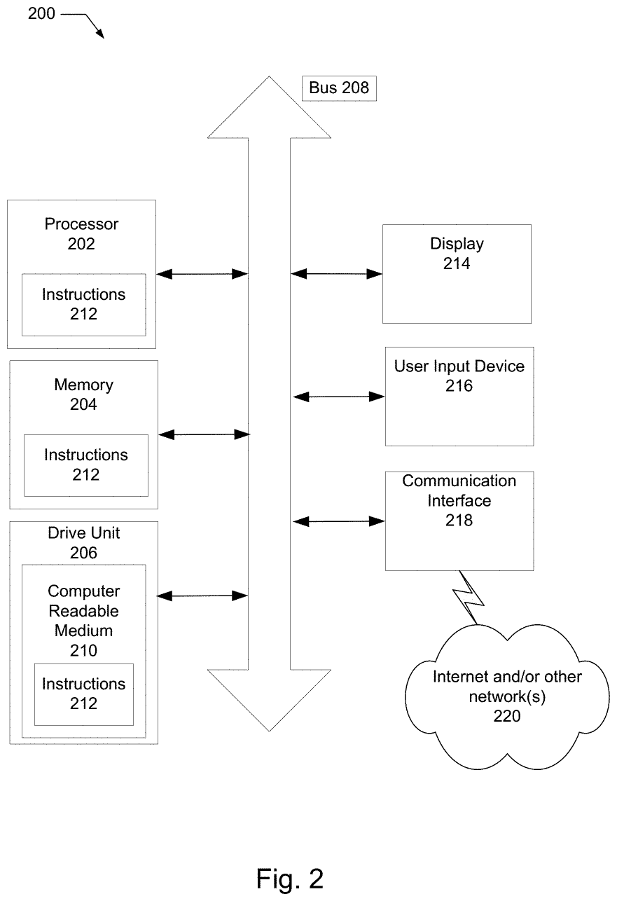

The exchange computer system 100 may be implemented with one or more mainframes, desktops, or other computers, such as the example computer 200 described herein with respect to FIG. 2. A user database 102 may be provided which includes information identifying traders and other users of exchange computer system 100, such as account numbers or identifiers, usernames, and passwords. An account data module 104 may be provided which may process account information that may be used during trades. The account data module 104 may store relationship information for the participants of the exchange. For example, the account data module 104 may store credit relationship data that defines credit relationships between participants. The account data module 104 may store data that defines which participants other participants are willing to trade with or otherwise complete contracts. Certain participants, for example, may wish to avoid trading with a competitor or otherwise unwelcome trading partner. Certain participants may be denied the opportunity to trade with other participants due to regulatory actions or legal reasons. A portfolio database 124 may be maintained by the account data module 104, as or part of separate from, the user database 102, and which is further coupled with the settlement module 120, described below. The portfolio database 124 stores one or more data records in association with each trader, or trading entity, which contain data indicative of current/open positions held by the trader or trading entity, such as positions in one or more futures contracts, or options thereon, which have not yet reached their maturity or have otherwise been offset or otherwise closed out. Each data record may store data indicative of the details of the position held by the trader/trading entity, such as side, quantity, settlement price, settlement date, etc. The portfolio database 124 may include, or be coupled with, logic or other functionality which may periodically evaluate the positions held by a trader/trading entity represented by the stored data to recognize one or more positions which offset one another and wherein positions which are completely offset may be removed from the database to reduce the data storage requirements thereof. Such functionality may be referred to as compression or portfolio compression and may be implemented by the settlement module 120 or the risk management module 114 as part of the analysis of the portfolio for margin determination.

A match engine module 106 may be included to match bid and offer prices and may be implemented with software that executes one or more algorithms for matching bids and offers. A trade database 108 may be included to store information identifying trades and descriptions of trades. Trade database 108 may store information identifying the time that a trade took place and the contract price. The positions created for each counterparty to a completed trade may then be stored as data records in the portfolio database 124 in association with the respective trader/trading entity, i.e. in the trader/trading entity's portfolio.

An order book module 110 may be included to compute or otherwise determine current bid and offer prices, e.g., in a continuous auction market, or also operate as an order accumulation buffer for a batch auction market.

A market data module 112 may be included to collect market data and prepare the data for transmission to users. For example, the market data module 112 may prepare the market data feeds described herein.

A risk management module 114 may be included to compute and determine a user's risk utilization in relation to the user's defined risk thresholds. The risk management module 114 may also be configured to determine risk assessments or exposure levels in connection with positions held by a market participant associated therewith in the portfolio database 124. The risk management module 114 may be configured to administer, manage, or maintain one or more margining mechanisms implemented by the exchange computer system 100. Such administration, management or maintenance may include managing database records reflective of margin accounts of the market participants. In some embodiments, the risk management module 114 implements one or more aspects of the disclosed embodiments, including, for instance, principal component analysis (PCA) based margining, in connection with interest rate swap (IRS) portfolios, as described herein.

A message management module 116 may be included to, among other things, receive, and extract orders from, electronic data transaction request messages. The message management module 116 may define a point of ingress into the exchange computer system 100 where messages are ordered and considered to be received by the system. This may be considered a point of determinism in the exchange computer system 100 that defines the earliest point where the system can ascribe an order of receipt to arriving messages. The point of determinism may or may not be at or near the demarcation point between the exchange computer system 100 and a public/internet network infrastructure. The message management module 116 processes messages by interpreting the contents of a message based on the message transmit protocol, such as the transmission control protocol (“TCP”), to provide the content of the message for further processing by the exchange computer system.

The message management module 116 may also be configured to detect characteristics of an order for a transaction to be undertaken in an electronic marketplace. For example, the message management module 116 may identify and extract order content such as a price, product, volume, and associated market participant for an order. The message management module 116 may also identify and extract data indicating an action to be executed by the exchange computer system 100 with respect to the extracted order. For example, the message management module 116 may determine the transaction type of the transaction requested in each message. A message may include an instruction to perform a type of transaction. The transaction type may be, in one embodiment, a request/offer/order to either buy or sell a specified quantity or units of a financial instrument at a specified price or value. The message management module 116 may also identify and extract other order information and other actions associated with the extracted order. All extracted order characteristics, other information, and associated actions extracted from a message for an order may be collectively considered an order as described and referenced herein.

Order or message characteristics may include, for example, the state of the system after a message is received, arrival time (e.g., the time a message arrives at the Market Segment Gateway (“MSG”) that is the point of ingress/entry and/or egress/departure for all transactions, i.e., the network traffic/packets containing the data therefore), message type (e.g., new, modify, cancel), and the number of matches generated by a message. Order or message characteristics may also include market participant side (e.g., buyer or seller) or time in force (e.g., a good until end of day order that is good for the full trading day, a good until canceled order that rests on the order book until matched, or a fill or kill order that is canceled if not filled immediately, or a fill and kill order (FOK) that is filled to the maximum amount possible based on the state of the order book at the time the FOK order is processed, and any remaining or unfilled/unsatisfied quantity is not stored on the books or allowed to rest).

An order processing module 118 (or order processor 118) may be included to decompose delta-based, spread instrument, bulk, and other types of composite orders for processing by the order book module 110 and/or the match engine module 106. The order processing module 118 may also be used to implement one or more procedures related to clearing an order. The order may be communicated from the message management module 116 to the order processing module 118. The order processing module 118 may be configured to interpret the communicated order, and manage the order characteristics, other information, and associated actions as they are processed through an order book module 110 and eventually transacted on an electronic market. For example, the order processing module 118 may store the order characteristics and other content and execute the associated actions. In an embodiment, the order processing module 118 may execute an associated action of placing the order into an order book for an electronic trading system managed by the order book module 110. In an embodiment, placing an order into an order book and/or into an electronic trading system may be considered a primary action for an order. The order processing module 118 may be configured in various arrangements and may be configured as part of the order book module 110, part of the message management module 116, or as an independent functioning module. The order processing module 136 may be configured to perform one or more market integrity checks for incoming transactions.

In an embodiment, the order processing module 118 may include one or more market integrity processors that implement market integrity mechanisms such as credit limits, credit banding, velocity logic, or circuit breakers as described below.

As an intermediary to electronic trading transactions, the exchange bears a certain amount of risk in each transaction that takes place. To that end, the clearing house implements processes by which trades are confirmed, matched and settled, as well as risk management mechanisms to protect the exchange. One or more of the modules of the exchange computer system 100 may be configured to determine settlement prices for constituent contracts, such as deferred month contracts, of spread instruments, such as for example, settlement module 120. A settlement module 120 (or settlement processor or other payment processor) may be included to provide one or more functions related to clearing, settling, e.g. regulating delivery and payment therefore, or otherwise administering transactions cleared by the exchange. Settlement module 120 of the exchange computer system 100 may implement one or more settlement price determination techniques. Settlement-related functions need not be limited to actions or events occurring at the end of a contract term. For instance, in some embodiments, settlement-related functions may include or involve daily or other mark to market settlements for margining purposes. In some cases, the settlement module 120 may be configured to communicate with the trade database 108 (or the memory(ies) on which the trade database 108 is stored) and/or to determine a payment amount based on a spot price, the price of the futures contract or other financial instrument, or other price data, at various times. The determination may be made at one or more points in time during the term of the financial instrument in connection with a margining mechanism. For example, the settlement module 120 may be used to determine a mark to market amount on a daily basis during the term of the financial instrument. Such determinations may also be made on a settlement date for the financial instrument for the purposes of final settlement.

Clearing functions implemented by settlement module 120 may be provided, not only for exchange traded instruments, such as futures and options thereon, but also for centrally cleared bilateral transactions. Centrally cleared bilateral transactions are transactions entered into bilaterally, i.e. directly between the parties or via a broker, where the parties have agreed to submit the transaction to a third-party clearing system to confirm the transaction details and complete the transaction, effect risk management over the life of the transaction, and settlement upon conclusion thereof.

In some embodiments, the settlement module 120 may be integrated to any desired extent with one or more of the other modules or processors of the exchange computer system 100. For example, the settlement module 120 and the risk management module 114 may be integrated to any desired extent. In some cases, one or more margining procedures or other aspects of the margining mechanism(s) may be implemented by the settlement module 120.

In one embodiment, where the clearing functions are provided independent of any exchange/trading functions, the settlement module 120 may be implemented by a central counterparty computing system separate from the exchange computer system 100.

In one embodiment, the exchange computer system 100 may further include a optimizer module 122, which may be a separate module or part of the settlement module 120. As will be described below, in one embodiment, the optimizer module 122 may implement the disclosed inter-portfolio optimization process, providing an interface, such as via a web site/page, by which a trading entity may request an optimization or by implementing an automated process which automatically evaluates portfolios. In one embodiment, the optimization module 122 may output a suggested set of transactions which may be accepted, submitted or otherwise approved by the trading entity in order to modify their portfolio to achieve the optimal margin determined by the optimization module 122. Alternatively, the optimization module 122 may automatically submit the determined transactions/modifications to the electronic trading system 100, e.g., to the settlement module 120 or clearing system. In an alternative embodiment, the optimization module 122 supports a standalone implementation of the disclosed optimization system, such as by providing an electronic source, e.g., an Application Program Interface, FTP site, or other mechanism, by which a standalone optimization computer program implemented in accordance with the disclosed embodiments may access the necessary portfolio and other data in order to perform the disclosed optimization process. In one embodiment, the optimization module 122 may further provide an interface by which the transaction necessary to achieve the optimized margin may be submitted to the electronic trading system 100, via the standalone optimization computer program or otherwise. Such a standalone optimization computer program may be made available as a software tool which trading entities may execute locally on their own computer systems.

One or more of the above-described modules of the exchange computer system 100 may be used to gather or obtain data to support the optimized margin determination, as well as a subsequent process to implement the necessary transactions to achieve the determined optimized margin. For example, the order book module 110 and/or the market data module 112 may be used to receive, access, or otherwise obtain market data, such as bid-offer values of orders currently on the order books. The trade database 108 may be used to receive, access, or otherwise obtain trade data indicative of the prices and volumes of trades that were recently executed in a number of markets. In some cases, transaction data (and/or bid/ask data) may be gathered or obtained from open outcry pits (where traders, or their representatives, all physically stand in a designated location, i.e., a trading pit, and trade with each other via oral and visual/hand based communication) and/or other sources and incorporated into the trade and market data from the electronic trading system(s). It should be appreciated that concurrent processing limits may be defined by or imposed separately or in combination on one or more of the trading system components.

The disclosed mechanisms may be implemented at any logical and/or physical point(s), or combinations thereof, at which the relevant information/data (e.g., message traffic and responses thereto) may be monitored or flows or is otherwise accessible or measurable, including one or more gateway devices, modems, the computers or terminals of one or more market participants, e.g., client computers, etc.

One skilled in the art will appreciate that one or more modules described herein may be implemented using, among other things, a tangible computer-readable medium comprising computer-executable instructions (e.g., executable software code). Alternatively, modules may be implemented as software code, firmware code, specifically configured hardware or processors, and/or a combination of the aforementioned. For example, the modules may be embodied as part of an exchange computer system 100 for financial instruments. It should be appreciated that the disclosed embodiments may be implemented as a different or separate module of the exchange computer system 100, or a separate computer system coupled with the exchange computer system 100 to have access to margin account record, pricing, and/or other data. As described herein, the disclosed embodiments may be implemented as a centrally accessible system or as a distributed system, e.g., where some of the disclosed functions are performed by the computer systems of the market participants.

The trading network environment shown in FIG. 1 includes exemplary computer devices 150, 152, 154, 156 and 158 which depict different exemplary methods or media by which a computer device may be coupled with the exchange computer system 100 or by which a user may communicate, e.g., send and receive, trade or other information therewith. It should be appreciated that the types of computer devices deployed by traders and the methods and media by which they communicate with the exchange computer system 100 is implementation dependent and may vary and that not all of the depicted computer devices and/or means/media of communication may be used and that other computer devices and/or means/media of communications, now available or later developed may be used. Each computer device, which may comprise a computer 200 described in more detail with respect to FIG. 2, may include a central processor, specifically configured or otherwise, that controls the overall operation of the computer and a system bus that connects the central processor to one or more conventional components, such as a network card or modem. Each computer device may also include a variety of interface units and drives for reading and writing data or files and communicating with other computer devices and with the exchange computer system 100. Depending on the type of computer device, a user can interact with the computer with a keyboard, pointing device, microphone, pen device or other input device now available or later developed.

An exemplary computer device 150 is shown directly connected to exchange computer system 100, such as via a TI line, a common local area network (LAN) or other wired and/or wireless medium for connecting computer devices, such as the network 220 shown in FIG. 2 and described with respect thereto. The exemplary computer device 150 is further shown connected to a radio 168. The user of radio 168, which may include a cellular telephone, smart phone, or other wireless proprietary and/or non-proprietary device, may be a trader or exchange employee. The radio user may transmit orders or other information to the exemplary computer device 150 or a user thereof. The user of the exemplary computer device 150, or the exemplary computer device 150 alone and/or autonomously, may then transmit the trade or other information to the exchange computer system 100.

Exemplary computer devices 152 and 154 are coupled with a local area network (“LAN”) 160 which may be configured in one or more of the well-known LAN topologies, e.g., star, daisy chain, etc., and may use a variety of different protocols, such as Ethernet, TCP/IP, etc. The exemplary computer devices 152 and 154 may communicate with each other and with other computer and other devices which are coupled with the LAN 160. Computer and other devices may be coupled with the LAN 160 via twisted pair wires, coaxial cable, fiber optics or other wired or wireless media. As shown in FIG. 1, an exemplary wireless personal digital assistant device (“PDA”) 158, such as a mobile telephone, tablet-based computer device, or other wireless device, may communicate with the LAN 160 and/or the Internet 162 via radio waves, such as via Wi-Fi, Bluetooth® and/or a cellular telephone-based data communications protocol. PDA 158 may also communicate with exchange computer system 100 via a conventional wireless hub 164.

FIG. 1 also shows the LAN 160 coupled with a wide area network (“WAN”) 162 which may be comprised of one or more public or private wired or wireless networks. In one embodiment, the WAN 162 includes the Internet 162. The LAN 160 may include a router to connect LAN 160 to the Internet 162. Exemplary computer device 156 is shown coupled directly to the Internet 162, such as via a modem, DSL line, satellite dish or any other device for connecting a computer device to the Internet 162 via a service provider therefore as is known. LAN 160 and/or WAN 162 may be the same as the network 220 shown in FIG. 2 and described with respect thereto.

Users of the exchange computer system 100 may include one or more market makers 130 which may maintain a market by providing constant bid and offer prices for a derivative or security to the exchange computer system 100, such as via one of the exemplary computer devices depicted. The exchange computer system 100 may also exchange information with other match or trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on a non-transitory computer-readable medium. For example, the exemplary computer device 152 may store computer-executable instructions for receiving order information from a user, transmitting that order information to exchange computer system 100 in electronic messages, extracting the order information from the electronic messages, executing actions relating to the messages, and/or calculating values from characteristics of the extracted order to facilitate matching orders and executing trades. In another example, the exemplary computer device 150 may include computer-executable instructions for receiving market data from exchange computer system 100 and displaying that information to a user.

Numerous additional servers, computers, handheld devices, personal digital assistants, telephones, and other devices may also be connected to exchange computer system 100. Moreover, one skilled in the art will appreciate that the topology shown in FIG. 1 is merely an example and that the components shown in FIG. 1 may include other components not shown and may be connected by numerous alternative topologies.

Referring now to FIG. 2, an illustrative embodiment of a general computer system 200 is shown. The computer system 200 can include a set of instructions that can be executed to cause the computer system 200 to perform any one or more of the methods or computer-based functions disclosed herein. The computer system 200 may operate as a standalone device or may be connected, e.g., using a network, to other computer systems or peripheral devices. Any of the components discussed herein, such as processor 202, may be a computer system 200 or a component in the computer system 200. The computer system 200 may be specifically configured to implement a match engine, margin processing, payment or clearing function on behalf of an exchange, such as the Chicago Mercantile Exchange Inc., of which the disclosed embodiments are a component thereof.

In a networked deployment, the computer system 200 may operate in the capacity of a server or as a client user computer in a client-server user network environment, or as a peer computer system in a peer-to-peer (or distributed) network environment. The computer system 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In an embodiment, the computer system 200 can be implemented using electronic devices that provide voice, video, or data communication. Further, while a single computer system 200 is illustrated, the term “system” shall also be taken to include any collection of systems or sub-systems that individually or jointly execute a set, or multiple sets, of instructions to perform one or more computer functions.

As illustrated in FIG. 2, the computer system 200 may include a processor 202, e.g., a central processing unit (CPU), a graphics processing unit (GPU), or both. The processor 202 may be a component in a variety of systems. For example, the processor 202 may be part of a standard personal computer or a workstation. The processor 202 may be one or more general processors, digital signal processors, specifically configured processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The computer system 200 may include a memory 204 that can communicate via a bus 208. The memory 204 may be a main memory, a static memory, or a dynamic memory. The memory 204 may include, but is not limited to, computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 204 includes a cache or random-access memory for the processor 202. In alternative embodiments, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disk, universal serial bus (“USB”) memory device, or any other device operative to store data. The memory 204 is operable to store instructions executable by the processor 202. The functions, acts or tasks illustrated in the figures or described herein may be performed by the programmed processor 202 executing the instructions 212 stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the computer system 200 may further include a display unit 214, such as a liquid crystal display (LCD), an organic light emitting diode (OLED), a flat panel display, a solid-state display, a cathode ray tube (CRT), a projector, a printer or other now known or later developed display device for outputting determined information. The display 214 may act as an interface for the user to see the functioning of the processor 202, or specifically as an interface with the software stored in the memory 204 or in the drive unit 206.

Additionally, the computer system 200 may include an input device 216 configured to allow a user to interact with any of the components of system 200. The input device 216 may be a number pad, a keyboard, or a cursor control device, such as a mouse, or a joystick, touch screen display, remote control, or any other device operative to interact with the system 200.

In an embodiment, as depicted in FIG. 2, the computer system 200 may also include a disk or optical drive unit 206. The disk drive unit 206 may include a computer-readable medium 210 in which one or more sets of instructions 212, e.g., software, can be embedded. Further, the instructions 212 may embody one or more of the methods or logic as described herein. In an embodiment, the instructions 212 may reside completely, or at least partially, within the memory 204 and/or within the processor 202 during execution by the computer system 200. The memory 204 and the processor 202 also may include computer-readable media as discussed herein.

The present disclosure contemplates a computer-readable medium that includes instructions 212 or receives and executes instructions 212 responsive to a propagated signal, so that a device connected to a network 220 can communicate voice, video, audio, images, or any other data over the network 220. Further, the instructions 212 may be transmitted or received over the network 220 via a communication interface 218. The communication interface 218 may be a part of the processor 202 or may be a separate component. The communication interface 218 may be created in software or may be a physical connection in hardware. The communication interface 218 is configured to connect with a network 220, external media, the display 214, or any other components in system 200, or combinations thereof. The connection with the network 220 may be a physical connection, such as a wired Ethernet connection or may be established wirelessly. Likewise, the additional connections with other components of the system 200 may be physical connections or may be established wirelessly.

The network 220 may include wired networks, wireless networks, or combinations thereof. The wireless network may be a cellular telephone network, an 802.11, 802.16, 802.20, or WiMAX network. Further, the network 220 may be a public network, such as the Internet, a private network, such as an intranet, or combinations thereof, and may utilize a variety of networking protocols now available or later developed including, but not limited to, TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus. While the computer-readable medium is shown to be a single medium, the term “computer-readable medium” includes a single medium or multiple medium, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein. The computer-readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated or otherwise specifically configured hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

Although the present specification describes components and functions that may be implemented in some embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical discs, or optical discs. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical discs; and CD ROM and DVD-ROM discs. The processor and the memory can be supplemented by, or incorporated in, special purpose logic circuitry.

As used herein, the terms “microprocessor” or “general-purpose processor” (“GPP”) may refer to a hardware device that fetches instructions and data from a memory or storage device and executes those instructions (for example, an Intel® Xeon® processor or an AMD Opteron™ processor) to then, for example, process the data in accordance therewith. The term “reconfigurable logic” may refer to any logic technology whose form and function can be significantly altered (i.e., reconfigured) in the field post-manufacture as opposed to a microprocessor, whose function can change post-manufacture, e.g., via computer executable software code, but whose form, e.g., the arrangement/layout and interconnection of logical structures, is fixed at manufacture. The term “software” may refer to data processing functionality that is deployed on a GPP. The term “firmware” may refer to data processing functionality that is deployed on reconfigurable logic. One example of a reconfigurable logic is a field programmable gate array (“FPGA”) which is a reconfigurable integrated circuit. An FPGA may contain programmable logic components called “logic blocks”, and a hierarchy of reconfigurable interconnects that allow the blocks to be “wired together”, somewhat like many (changeable) logic gates that can be inter-wired in (many) different configurations. Logic blocks may be configured to perform complex combinatorial functions, or merely simple logic gates like AND, OR, NOT and XOR. An FPGA may further include memory elements, which may be simple flip-flops or more complete blocks of memory.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well. Feedback provided to the user can be any form of sensory feedback, e.g., visual feedback, auditory feedback, or tactile feedback. Input from the user can be received in any form, including acoustic, speech, or tactile input.

Embodiments of the subject matter described in this specification can be implemented in a computing system that includes a back-end component, e.g., a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

It should be appreciated that the disclosed embodiments may be applicable to other types of messages depending upon the implementation. Further, the messages may comprise one or more data packets, datagrams or other collection of data formatted, arranged configured and/or packaged in a particular one or more protocols, e.g., the FIX protocol, TCP/IP, Ethernet, etc., suitable for transmission via a network 214 as was described, such as the message format and/or protocols described in U.S. Pat. No. 7,831,491 and U.S. Patent Publication No. 2005/0096999 A1, both of which are incorporated by reference herein in their entireties and relied upon. Further, the disclosed message management system may be implemented using an open message standard implementation, such as FIX, FIX Binary, FIX/FAST, or by an exchange-provided API.

### Inter-Portfolio Optimization

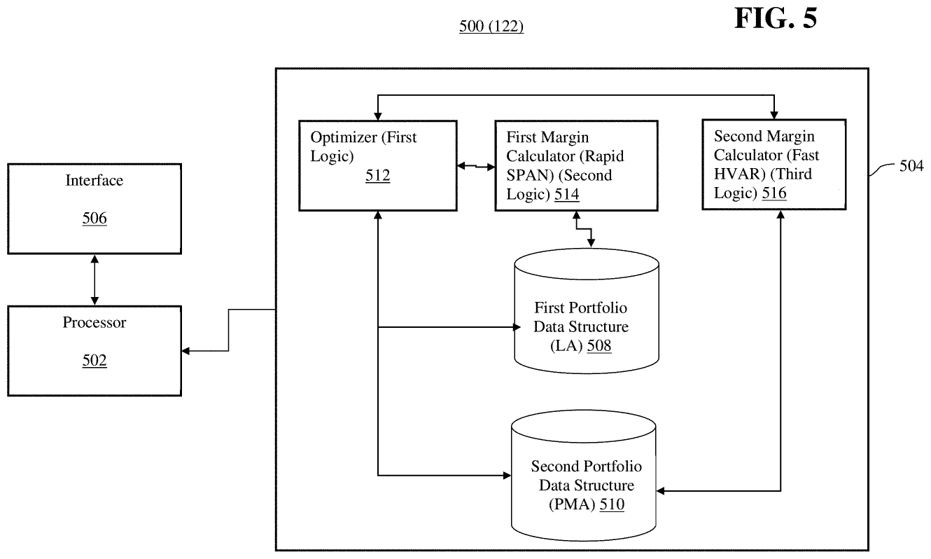

FIG. 5 depicts a block diagram of a system 500, which may be implemented as a standalone computer program, for determining an optimized margin value for a portfolio as described herein. It will be appreciated that the system 500 may be a part of, or in communication with the Optimizer Module 122, or other module of the exchange computer system 100 described above and shown in FIG. 1, or part of, or in communication with, settlement or clearing systems. Alternatively, the system 500 may be part of a central counterparty computer system separate from, but in electronic communication with, the exchange computer system 100. The system 500 includes a processor 502, and a non-transitory memory 504, such as the processor and memory which implement the exchange computer system, and transaction/user interface 506 coupled therewith, such as the processor 202, memory 204 and/or interfaces 214, 216, 218 described in detail above with reference to FIG. 2. In one embodiment, the transaction/user interface 506 is directly or indirectly coupled with the portfolio database 124 or other database, internal or external to the exchange computer system 100, which stores data representative of both Listed and OTC positions held by a given trading entity. Alternatively, or in addition thereto, the transaction interface 506 receives messages communicated from an external Listed and bilateral contract management systems, such as a clearing system, indicating positions entered into or otherwise held by a trading entity. The transaction/user interface 506 may further provide a user interface with which a trading entity may interact to request or initiate the disclosed optimization process and/or obtain the results thereof, as described herein.

The system 500 includes a first portfolio data structure 508 stored in the memory 504 and comprising data indicative of at least a subset of a first set of positions entered into by a trading entity in a first set of financial instruments characterized by a first instrument type, the data indicative of each of the first set of positions being initially stored in the first portfolio data structure upon creation of the position. In one embodiment, the first set of positions are Listed positions such as positions held by the trading entity in one or more futures contracts traded on the electronic trading system 100 described above. The system 500 further includes a second portfolio data structure 510 stored in the memory 504 separate from the first portfolio data structure 508 and comprising data indicative of those of the first set of positions not stored in the first portfolio data structure and data indicative of a second set of positions entered into by the trading entity in a second set of instruments characterized by a second instrument type different from the first instrument type, the data indicative of each of the second set of positions being stored only in the second portfolio data structure. In one embodiment, the second portfolio data structure 510 stores OTC positions, such as positions in interest rate swap instruments held by the trading entity, as well as any Listed positions moved into the second portfolio data structure 510 as a result of prior operation of the system 500, as described herein.

Each position of the first and second sets of positions is characterized by a plurality of scenarios, e.g., possible future market values/conditions, in which the position may be satisfied based on a future event, each scenario of which may result in one of a gain or loss in value for the trading entity, a combination the first set of positions and a combination of the second sets of positions being each characterized by one of a net gain or loss in value for the trading entity, a combination of the net gain or loss in value for the first and second sets of positions forming a total gain or loss in value for the trading entity.

Further, as noted herein, only the data indicative of any of the first set of positions, i.e., the Listed positions, may be transferred between the first portfolio data structure and the second portfolio data structure.

The system 500 further includes an optimizer 512 which is coupled with first and second margin calculators 514 516. The optimizer 512 and/or first and second margin calculators 514 516 may be implemented as computer executable instructions stored in the memory 504, such as in the form of one or more logic components, e.g. first through third logic components 512 514 516, that when executed by the processor 502, cause the processor 502 to operate as described. Alternatively, the above computer executable instructions or logic components 512 514 516 may be implemented as one or more separate components, such as on an FPGA which may include a memory or reconfigurable component to store logic and a processing component to execute the stored logic.

In one embodiment, the optimizer 512 is operative or otherwise configured to iteratively generate each of a plurality of first and second hypothetical portfolio data sets, based on the first and second portfolio data structures, by, upon each iteration, varying which data indicative of a subset of the first set of positions are included in the first hypothetical portfolio data set, a remainder of the first set of positions being included in the second hypothetical portfolio data set which also include data indicative of the second set of positions, and communicate the generated first hypothetical portfolio data set to the first margin calculator 514 coupled with the optimizer 512 and communicate the second hypothetical portfolio data set to the second margin calculator 516 coupled with the optimizer 512. As described above, in one embodiment, the optimizer 512 determines one or more offsets, e.g. allocation scenarios, in which one or more Listed positions are moved between the portfolio data structures, e.g., the LA and PMA, for which the total margin will be tested to determine if it the optimal.

The first margin calculator 514 is operative to perform a first set of processing steps, e.g., Rapid SPAN, to compute a first approximate net gain or loss value for each of the first hypothetical portfolio data sets based on the data therein according to a first algorithm, wherein the first set of processing steps comprises a first subset of processing steps, e.g., an initialization phase, which are only performed once for all of the first hypothetical portfolio data sets generated by the optimizer 512 and a second subset of processing steps which are performed, e.g., during calculation phase, for each of the first hypothetical portfolio data sets.

The second margin calculator 516 is operative to perform a second set of processing steps, e.g., Fast HVAR, to compute a second approximate net gain or loss value for each of the second hypothetical portfolio data sets based on the data therein according to a second algorithm different from the first algorithm, wherein the second set of processing steps comprises a first subset of processing steps which are only performed, e.g., during an initialization phase, once for all of the second hypothetical portfolio data sets generated by the optimizer 510 and a second subset of processing steps which are performed, e.g., during a calculation phase, for each of the second hypothetical portfolio data sets.

Wherein the optimizer 512 calculates, for each iteration of the first and second hypothetical portfolio data sets a combined hypothetical total gain or loss value, e.g., total hypothetical margin value, based on the first and second approximate net gain or loss values generated by the first and second margin calculators, until the combined hypothetical total gain or loss value calculated for a given iteration is determined to be a minimum of the combined hypothetical total gain or loss value calculated for all of the iterations. In one embodiment, the process continues until the minimum value is found. Alternatively, the process ceases once a threshold minimum is reached or, alternatively, a maximum number of iterations is reached.

In one embodiment, the first instrument type comprises a futures contract listed via an electronic trading system and the second instrument type comprises an over the counter swap.

In one embodiment, the optimizer 512 comprises a differential evolution optimizer.

In one embodiment, the optimizer 512 is operative to not attempt to calculate a gradient, to not get trapped in local minima, utilizes a low population while converging.

In one embodiment, the first margin calculator 514 comprises an algorithm which approximates SPAN.

In one embodiment, the second margin calculator 514 comprises an algorithm which approximates HVAR.

In one embodiment, the optimizer 512 is further operative, upon the determination of the minimum of the combined hypothetical total gain or loss value calculated for all of the iterations, to generate a set of transactions which, when executed, alter the data stored in the first and second portfolio data structures to be in accordance with the first and second hypothetical portfolio data set which resulted in the minimum of the combined hypothetical total gain or loss value calculated for all of the iterations. In one embodiment, the set of transactions comprise a set of FIX transaction messages which may be submitted to an electronic trading system 100.

In one embodiment, the optimizer 512 is further operative, upon the determination of the minimum of the combined hypothetical total gain or loss value calculated for all of the iterations, to execute a set of transactions which alter the data stored in the first and second portfolio data structures 508 510 to be in accordance with the first and second hypothetical portfolio data set which resulted in the minimum of the combined hypothetical total gain or loss value calculated for all of the iterations.

In one embodiment, the optimizer 512 is coupled with a user interface 506 and is further operative to present data indicative of each of first and second hypothetical portfolio data sets and resultant combined hypothetical total gain or loss value, the first and second hypothetical portfolio data sets which resulted in the minimum of the combined hypothetical total gain or loss value calculated for all of the iterations, the minimum of the combined hypothetical total gain or loss value calculated for all of the iterations, or a combination thereof.

In one embodiment, the optimizer 512 is executed at the end of a trading session based on the first and second portfolio data structures 508 510 resulting therefrom.

In one embodiment, the optimizer 512 is executed prior to computation and collection of variation margin by an electronic trading system 100.

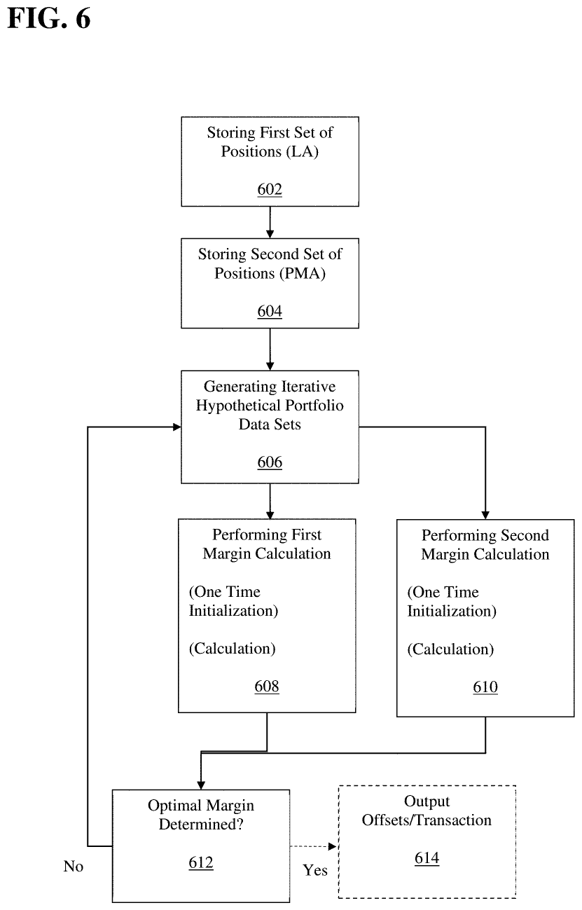

FIG. 6 depicts a flow chart showing operation of the system 500 of FIGS. 1-5. In particular FIG. 6 shows a method, which may be computer implemented, for identifying or otherwise determining an optimal margin value for a portfolio wherein the operation of the system includes: storing by a processor 502 in a memory 504 coupled therewith, a first portfolio data structure 508 comprising data indicative of at least a subset of a first set of positions entered into by a trading entity in a first set of financial instruments characterized by a first instrument type, the data indicative of each of the first set of positions being initially stored in the first portfolio data structure 508 upon creation of the position (Block 602); and storing, by the processor 502 in the memory 504, a second portfolio data structure 510 separate from the first portfolio data structure 508 and comprising data indicative of those of the first set of positions not stored in the first portfolio data structure 508 and data indicative of a second set of positions entered into by the trading entity in a second set of instruments characterized by a second instrument type different from the first instrument type, the data indicative of each of the second set of positions being stored only in the second portfolio data structure 510 (Block 604). Wherein each position of the first and second sets of positions characterized by a plurality of scenarios in which the position may be satisfied based on a future event, each scenario of which may result in one of a gain or loss in value for the trading entity, a combination the first set of positions and a combination of the second sets of positions being each characterized by one of a net gain or loss in value for the trading entity, a combination of the net gain or loss in value for the first and second sets of positions forming a total gain or loss in value for the trading entity; and wherein only the data indicative of any of the first set of positions may be transferred between the first portfolio data structure 508 and the second portfolio data structure 510.

The operation of the system 500 further includes generating, iteratively by the processor 502, each of a plurality of first and second hypothetical portfolio data sets, based on the first and second portfolio data structures, by, upon each iteration, varying which data indicative of a subset of the first set of positions are included in the first hypothetical portfolio data set, a remainder of the first set of positions being included in the second hypothetical portfolio data set which also include data indicative of the second set of positions, and communicating the generated first hypothetical portfolio data set to a first margin calculator 514 coupled with, or alternatively implemented by, the processor 502 and communicating the second hypothetical portfolio data set to a second margin calculator 516 coupled with, or alternatively implemented by, the processor (Block 606); performing, by the first margin calculator 514, a first set of processing steps to compute a first approximate net gain or loss value for each of the first hypothetical portfolio data sets based on the data therein according to a first algorithm, wherein the first set of processing steps comprises a first subset of processing steps which are only performed once for all of the first hypothetical portfolio data sets generated by the processor 502 and a second subset of processing steps which are performed for each of the first hypothetical portfolio data sets (Block 608); performing, by the second margin calculator 514, a second set of processing steps to compute a second approximate net gain or loss value for each of the second hypothetical portfolio data sets based on the data therein according to a second algorithm different from the first algorithm, wherein the second set of processing steps comprises a first subset of processing steps which are only performed once for all of the second hypothetical portfolio data sets generated by the processor 502 and a second subset of processing steps which are performed for each of the second hypothetical portfolio data sets (Block 610); and calculating, by the processor, for each iteration of the first and second hypothetical portfolio data sets a combined hypothetical total gain or loss value based on the first and second approximate net gain or loss values generated by the first and second margin calculators 512 514, until the combined hypothetical total gain or loss value calculated for a given iteration is determined to be a minimum of the combined hypothetical total gain or loss value calculated for all of the iterations (Block 612).

In one embodiment, the first instrument type comprises a futures contract listed via an electronic trading system and the second instrument type comprises an over the counter swap.

In one embodiment, the processor 502 implements a differential evolution optimizer.

In one embodiment, the processor 502 does not attempt to calculate a gradient, does not get trapped in local minima, and utilizes a low population while converging.

In one embodiment, the first margin calculator 514 comprises an algorithm which approximates SPAN.

In one embodiment, the second margin calculator 516 comprises an algorithm which approximates HVAR.

In one embodiment, the operation of the system 500 further includes, upon the determination of the minimum of the combined hypothetical total gain or loss value calculated for all of the iterations, generating, by the processor 502, a set of transactions which, when executed, alter the data stored in the first and second portfolio data structures 508 510 to be in accordance with the first and second hypothetical portfolio data set which resulted in the minimum of the combined hypothetical total gain or loss value calculated for all of the iterations (Block 614). In one embodiment, the set of transactions comprises a set of FIX transaction messages which may be submitted to an electronic trading system.

In one embodiment, the operation of the system 500 further includes, upon the determination of the minimum of the combined hypothetical total gain or loss value calculated for all of the iterations, executing, by the processor 502, a set of transactions which alter the data stored in the first and second portfolio data structures 508 510 to be in accordance with the first and second hypothetical portfolio data set which resulted in the minimum of the combined hypothetical total gain or loss value calculated for all of the iterations (Block 614).

In one embodiment, the operation of the system 500 further includes presenting, by the processor 502 via a user interface 506 coupled therewith, data indicative of each of first and second hypothetical portfolio data sets and resultant combined hypothetical total gain or loss value, the first and second hypothetical portfolio data set which resulted in the minimum of the combined hypothetical total gain or loss value calculated for all of the iterations, the minimum of the combined hypothetical total gain or loss value calculated for all of the iterations, or a combination thereof (Block 614).

In one embodiment, the operation of the system 500 further includes executing, by the processor 502, the method at the end of a trading session based on the first and second portfolio data structures resulting therefrom.

In one embodiment, the operation of the system 500 further includes executing, by the processor, 502 the method prior to computation and collection of variation margin by an electronic trading system 100.

### CONCLUSION

The illustrations of the embodiments described herein are intended to provide a general understanding of the structure of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the described embodiments should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

1. A system comprising:
a first portfolio data structure stored in a memory and comprising data indicative of at least a subset of a first set of positions entered into by a trading entity in a first set of financial instruments characterized by a first instrument type, the data indicative of each of the first set of positions being initially stored in the first portfolio data structure upon creation of the position;
a second portfolio data structure stored in the memory separate from the first portfolio data structure and comprising data indicative of those of the first set of positions not stored in the first portfolio data structure and data indicative of a second set of positions entered into by the trading entity in a second set of instruments characterized by a second instrument type different from the first instrument type, the data indicative of each of the second set of positions being stored only in the second portfolio data structure;
each position of the first and second sets of positions characterized by a plurality of scenarios in which the position is satisfied based on a future event, each scenario of which resultant in one of a gain or loss in value for the trading entity, a combination the first set of positions and a combination of the second sets of positions being each characterized by one of a net gain or loss in value for the trading entity, a combination of the net gain or loss in value for the first and second sets of positions forming a total gain or loss in value for the trading entity;
wherein only the data indicative of any of the first set of positions may be transferred between the first portfolio data structure and the second portfolio data structure;
an optimizer operative to iteratively generate each of a plurality of first and second hypothetical portfolio data sets, based on the first and second portfolio data structures, by, upon each iteration, varying which data indicative of a subset of the first set of positions are included in the first hypothetical portfolio data set, a remainder of the first set of positions being included in the second hypothetical portfolio data set which also include data indicative of the second set of positions, and communicate the generated first hypothetical portfolio data set to a first margin calculator coupled with the optimizer and communicate the second hypothetical portfolio data set to a second margin calculator coupled with the optimizer;
the first margin calculator being operative to perform a first set of processing steps to compute a first approximate net gain or loss value for each of the first hypothetical portfolio data sets based on the data therein according to a first algorithm, wherein the first set of processing steps comprises a first subset of processing steps which are only performed once for all of the first hypothetical portfolio data sets generated by the optimizer and a second subset of processing steps which are performed for each of the first hypothetical portfolio data sets;
the second margin calculator being operative to perform a second set of processing steps to compute a second approximate net gain or loss value for each of the second hypothetical portfolio data sets based on the data therein according to a second algorithm different from the first algorithm, wherein the second set of processing steps comprises a first subset of processing steps which are only performed once for all of the second hypothetical portfolio data sets generated by the optimizer and a second subset of processing steps which are performed for each of the second hypothetical portfolio data sets; and
wherein the optimizer calculates, for each iteration of the first and second hypothetical portfolio data sets a combined hypothetical total gain or loss value based on the first and second approximate net gain or loss values generated by the first and second margin calculators, until the combined hypothetical total gain or loss value calculated for a given iteration is determined to be a minimum of the combined hypothetical total gain or loss value calculated for all of the iterations.

2. The system of claim 1, wherein the first instrument type comprises a futures contract listed via an electronic trading system and the second instrument type comprises an over the counter swap.

3. The system of claim 1, wherein the optimizer comprises a differential evolution optimizer.

4. (canceled)

5. The system of claim 1, wherein the first margin calculator comprises an algorithm which approximates a Standard Portfolio Analysis of Risk (SPAN) model.

6. The system of claim 1, wherein the second margin calculator comprises an algorithm which approximates a Historical Value at Risk (HVAR) model.

7. The system of claim 1, wherein the optimizer is further operative, upon the determination of the minimum of the combined hypothetical total gain or loss value calculated for all of the iterations, to generate a set of transactions which, when executed, alter the data stored in the first and second portfolio data structures to be in accordance with the first and second hypothetical portfolio data set which resulted in the minimum of the combined hypothetical total gain or loss value calculated for all of the iterations.

8. The system of claim 7, wherein the set of transactions comprise a set of Financial Information eXchange (FIX) transaction messages which may be submitted to an electronic trading system.

9. The system of claim 1, wherein the optimizer is further operative, upon the determination of the minimum of the combined hypothetical total gain or loss value calculated for all of the iterations, to execute a set of transactions which alter the data stored in the first and second portfolio data structures to be in accordance with the first and second hypothetical portfolio data set which resulted in the minimum of the combined hypothetical total gain or loss value calculated for all of the iterations.

10. The system of claim 1, wherein the optimizer is coupled with a user interface and is further operative to present data indicative of each of first and second hypothetical portfolio data sets and resultant combined hypothetical total gain or loss value, the first and second hypothetical portfolio data sets which resulted in the minimum of the combined hypothetical total gain or loss value calculated for all of the iterations, the minimum of the combined hypothetical total gain or loss value calculated for all of the iterations, or a combination thereof.

11. The system of claim 1, wherein the optimizer is executed at the end of a trading session based on the first and second portfolio data structures resulting therefrom.

12. The system of claim 1, wherein the optimizer is executed prior to computation and collection of variation margin by an electronic trading system.

13. The system of claim 1, wherein the optimizer is implemented as a standalone computer program.

14. A computer implemented method comprising:
storing by a processor in a memory coupled therewith, a first portfolio data structure comprising data indicative of at least a subset of a first set of positions entered into by a trading entity in a first set of financial instruments characterized by a first instrument type, the data indicative of each of the first set of positions being initially stored in the first portfolio data structure upon creation of the position;
storing, by the processor in the memory, a second portfolio data structure separate from the first portfolio data structure and comprising data indicative of those of the first set of positions not stored in the first portfolio data structure and data indicative of a second set of positions entered into by the trading entity in a second set of instruments characterized by a second instrument type different from the first instrument type, the data indicative of each of the second set of positions being stored only in the second portfolio data structure;
wherein each position of the first and second sets of positions characterized by a plurality of scenarios in which the position is satisfied based on a future event, each scenario of which resultant in one of a gain or loss in value for the trading entity, a combination the first set of positions and a combination of the second sets of positions being each characterized by one of a net gain or loss in value for the trading entity, a combination of the net gain or loss in value for the first and second sets of positions forming a total gain or loss in value for the trading entity;
wherein only the data indicative of any of the first set of positions may be transferred between the first portfolio data structure and the second portfolio data structure;
generating, iteratively by the processor, each of a plurality of first and second hypothetical portfolio data sets, based on the first and second portfolio data structures, by, upon each iteration, varying which data indicative of a subset of the first set of positions are included in the first hypothetical portfolio data set, a remainder of the first set of positions being included in the second hypothetical portfolio data set which also include data indicative of the second set of positions, and communicating the generated first hypothetical portfolio data set to a first margin calculator coupled with the processor and communicating the second hypothetical portfolio data set to a second margin calculator coupled with the processor;
performing, by the first margin calculator, a first set of processing steps to compute a first approximate net gain or loss value for each of the first hypothetical portfolio data sets based on the data therein according to a first algorithm, wherein the first set of processing steps comprises a first subset of processing steps which are only performed once for all of the first hypothetical portfolio data sets generated by the processor and a second subset of processing steps which are performed for each of the first hypothetical portfolio data sets;
performing, by the second margin calculator, a second set of processing steps to compute a second approximate net gain or loss value for each of the second hypothetical portfolio data sets based on the data therein according to a second algorithm different from the first algorithm, wherein the second set of processing steps comprises a first subset of processing steps which are only performed once for all of the second hypothetical portfolio data sets generated by the processor and a second subset of processing steps which are performed for each of the second hypothetical portfolio data sets; and
calculating, by the processor, for each iteration of the first and second hypothetical portfolio data sets a combined hypothetical total gain or loss value based on the first and second approximate net gain or loss values generated by the first and second margin calculators, until the combined hypothetical total gain or loss value calculated for a given iteration is determined to be a minimum of the combined hypothetical total gain or loss value calculated for all of the iterations.

15. The method of claim 14, wherein the first instrument type comprises a futures contract listed via an electronic trading system and the second instrument type comprises an over the counter swap.

16. The method of claim 14, wherein the processor implements a differential evolution optimizer.

17. (canceled)

18. The method of claim 14, wherein the first margin calculator comprises an algorithm which approximates a Standard Portfolio Analysis of Risk (SPAN) model.

19. The method of claim 14, wherein the second margin calculator comprises an algorithm which approximates a Historical Value at Risk (HVAR) model.

20. The method of claim 14, further comprising, upon the determination of the minimum of the combined hypothetical total gain or loss value calculated for all of the iterations, generating, by the processor, a set of transactions which, when executed, alter the data stored in the first and second portfolio data structures to be in accordance with the first and second hypothetical portfolio data set which resulted in the minimum of the combined hypothetical total gain or loss value calculated for all of the iterations.

21. The method of claim 20, wherein the set of transactions comprises a set of Financial Information eXchange (FIX) transaction messages which may be submitted to an electronic trading system.

22. The method of claim 14, further comprising, upon the determination of the minimum of the combined hypothetical total gain or loss value calculated for all of the iterations, executing, by the processor, a set of transactions which alter the data stored in the first and second portfolio data structures to be in accordance with the first and second hypothetical portfolio data set which resulted in the minimum of the combined hypothetical total gain or loss value calculated for all of the iterations.

23. The method of claim 14, further comprising presenting, by the processor via a user interface coupled therewith, data indicative of each of first and second hypothetical portfolio data sets and resultant combined hypothetical total gain or loss value, the first and second hypothetical portfolio data set which resulted in the minimum of the combined hypothetical total gain or loss value calculated for all of the iterations, the minimum of the combined hypothetical total gain or loss value calculated for all of the iterations, or a combination thereof.

24. The method of claim 14, further comprising executing, by the processor, the method at the end of a trading session based on the first and second portfolio data structures resulting therefrom.

25. The method of claim 14, further comprising executing, by the processor, the method prior to computation and collection of variation margin by an electronic trading system.

26. The method of claim 14, wherein the method is implemented by a standalone computer program.

27. A system comprising:
means for storing in a memory, a first portfolio data structure comprising data indicative of at least a subset of a first set of positions entered into by a trading entity in a first set of financial instruments characterized by a first instrument type, the data indicative of each of the first set of positions being initially stored in the first portfolio data structure upon creation of the position;
means for storing, in the memory, a second portfolio data structure separate from the first portfolio data structure and comprising data indicative of those of the first set of positions not stored in the first portfolio data structure and data indicative of a second set of positions entered into by the trading entity in a second set of instruments characterized by a second instrument type different from the first instrument type, the data indicative of each of the second set of positions being stored only in the second portfolio data structure;
wherein each position of the first and second sets of positions characterized by a plurality of scenarios in which the position is satisfied based on a future event, each scenario of which resultant in one of a gain or loss in value for the trading entity, a combination the first set of positions and a combination of the second sets of positions being each characterized by one of a net gain or loss in value for the trading entity, a combination of the net gain or loss in value for the first and second sets of positions forming a total gain or loss in value for the trading entity;
wherein only the data indicative of any of the first set of positions may be transferred between the first portfolio data structure and the second portfolio data structure;
means for generating, iteratively, each of a plurality of first and second hypothetical portfolio data sets, based on the first and second portfolio data structures, by, upon each iteration, varying which data indicative of a subset of the first set of positions are included in the first hypothetical portfolio data set, a remainder of the first set of positions being included in the second hypothetical portfolio data set which also include data indicative of the second set of positions, and communicating the generated first hypothetical portfolio data set to a first margin calculator coupled with the processor and communicating the second hypothetical portfolio data set to a second margin calculator coupled with the processor;
means for performing a first set of processing steps to compute a first approximate net gain or loss value for each of the first hypothetical portfolio data sets based on the data therein according to a first algorithm, wherein the first set of processing steps comprises a first subset of processing steps which are only performed once for all of the first hypothetical portfolio data sets generated by the optimizer and a second subset of processing steps which are performed for each of the first hypothetical portfolio data sets;
means for performing a second set of processing steps to compute a second approximate net gain or loss value for each of the second hypothetical portfolio data sets based on the data therein according to a second algorithm different from the first algorithm, wherein the second set of processing steps comprises a first subset of processing steps which are only performed once for all of the second hypothetical portfolio data sets generated by the optimizer and a second subset of processing steps which are performed for each of the second hypothetical portfolio data sets; and
means for calculating, for each iteration of the first and second hypothetical portfolio data sets a combined hypothetical total gain or loss value based on the first and second approximate net gain or loss values generated by the first and second margin calculators, until the combined hypothetical total gain or loss value calculated for a given iteration is determined to be a minimum of the combined hypothetical total gain or loss value calculated for all of the iterations.

28. A computer-implemented method for modifying a plurality of data records stored in a memory of a data transaction processing system in which data items are transacted by a hardware matching processor that matches electronic data transaction request messages for the same one of the data items based on multiple transaction parameters from different client computers over a data communication network, each of the plurality of data records comprising data indicative of a result of the operation of the hardware matching processor with respect to a data item and characterized by a risk value, wherein a first subset of the plurality of data records are associated with a first account of a trader and a second subset of the plurality of data records are associated with a second account of the trader, the first and second subsets not overlapping, the first subset comprising data records of a first type and the second subset comprising data records of the first type and a second type different from the first type and not present in the first subset, the first and second accounts being characterized by a combined risk value computed based on the risk values of data records of the first and second subsets of the plurality of data records, the method comprising:
retrieving, automatically by a processor of the data transaction processing system from the memory, the data stored in the first and second subsets of the plurality of data records;
determining, automatically by the processor, an optimal reallocation of the data stored in the first and second subsets of the plurality of data records between the first and second subsets which results in a total risk value for the first and second subsets of the plurality of data records that is less than the combined value, the determining further comprising processing the combination of the risk values of the plurality of data records of the first and second subsets to determine an effect on a net risk value of the first subset and a net risk value of the second subset of moving one or more data records of the first type between the first subset and the second subset on the combination of the risk values without actually moving any of the data records wherein the movement of the one or more data records would cause a change in the net risk value of both the first and second subsets;
wherein the determining of the optimal reallocation further includes computing a first risk value for the first subset of the plurality of data records using a first two phase risk value approximation process which implements a first process performed for the entire determining of the optimal reallocation and a second process performed for each first subset, the determining of the optimal reallocation further including computing a second risk value for the second subset of the plurality of data records using a second two phase risk value approximation process which implements a third process performed for the entire determining of the optimal reallocation and a fourth process performed for each second subset;
determining, automatically by the processor, one or more modifications to the data of the data records of the first subset, the second subset, or a combination thereof to achieve the determined optimal reallocation, the modifications comprising adding or removing one or more data records of the first type from the first subset, the second subset or a combination thereof which results in the lowest combination of volatility values of the first and second subsets;
generating, automatically by the processor, a set of proposed data transaction request messages to communicate to the hardware matching processor, each having multiple transaction parameters configured to effect the determined one or more modifications; and
transacting, by the hardware matching processor, the proposed set of data transaction request messages, wherein the data of the data records of the first subset, the second subset, or a combination thereof are modified thereby.

29. The computer-implemented method of claim 28, wherein the first account comprises an interest rate futures account, and wherein the second account comprises an over-the-counter interest rate swap account, and wherein the first type comprises an interest rate futures position and the second type comprises an over-the-counter interest rate swap position.

30. The computer-implemented method of claim 28, wherein the data stored in the first and second subset of the plurality of data records represents information selected from the group consisting of an expression of risk for a margin account of the trader, composite delta statistics for all data which may be stored in the first subset of data records, over-the-counter interest rate swap data from an over-the-counter interest rate swap clearing system, base curves, foreign exchange rates, futures data and pricing for computation of risk offsets of Eurodollar and Treasury futures, a current allocation of futures within a Portfolio Margin (PM) account and futures/options contracts within a segregated futures position account, and combinations thereof.

31. The computer-implemented method of claim 30, wherein the first subset of the plurality of data records corresponds to the trader's interest rate futures account, the data stored therein representing Eurodollar futures, Eurodollar options, Treasury futures, Treasury options, or combinations thereof.

32. The computer-implemented method of claim 28, further comprising formatting, by the processor, the set of data transaction request messages in a protocol which may be acted on by an Exchange.

33. The computer-implemented method of claim 32, wherein the protocol comprises a Financial Information eXchange (FIX) protocol, which may be acted on by an Exchange.

34. The system of claim 1, wherein the optimizer is operative to execute without reliance on a gradient descent algorithm, to avoid identification of a local minimum as a global minimum, and to operate when in the plurality of scenarios includes 20 or fewer scenarios.

35. The method of claim 14, wherein the processor executes without reliance on a gradient descent algorithm, avoids identification of a local minimum as a global minimum, and operates when in the plurality of scenarios includes 20 or fewer scenarios.
